(19) United States
(12) Patent Application Publication
(10) Pub. No.: US 2012/0284506 A1
(43) Pub. Date: Nov. 8, 2012

(54) METHODS AND APPARATUS FOR PREVENTING CRIMEWARE ATTACKS

(75) Inventors: David W. KRAVITZ, Fairfax, VA (US); Donald H. GRAHAM, III, Los Angeles, CA (US); Josselyn BOUDETT, Los Angeles, CA (US)

(73) Assignee: T-Central, Inc., San Mateo, CA (US)

(21) Appl. No.: 13/481,553

(22) Filed: May 25, 2012

Related U.S. Application Data
(63) Continuation-in-part of application No. 13/096,764, filed on Apr. 28, 2011.
(60) Provisional application No. 61/490,952, filed on May 27, 2011.
(60) Provisional application No. 61/650,866, filed on May 23, 2012.
(60) Provisional application No. 61/330,226, filed on Apr. 30, 2010.
(60) Provisional application No. 61/367,574, filed on Jul. 26, 2010.
(60) Provisional application No. 61/367,576, filed on Jul. 26, 2010.
(60) Provisional application No. 61/416,629, filed on Nov. 23, 2010.

(51) Int. Cl. G06F 21/00; H04L 29/06

(52) U.S. Cl. 713/151; 726/3; 713/150

(57) ABSTRACT

A central server configured to mediate communications including establishing secure online sessions between user-controlled devices and 3^{rd} party devices, such as a 3^{rd} party device hosting a financial site. The methods and apparatus used to instantiate and carry out the mediated communications can be designed to thwart crimeware. To enable communications between the user-controlled devices and the 3^{rd} party devices, the central server can be configured to instantiate a first secure communication session between the central server and the user-controlled device and a second secure communication session between the central server and the 3^{rd} party device. If desired, separate encryption keys can be used for the first communication session and the second communication session where only the central server possesses the encryption keys for both the first communication session and the second communication session. Optionally, after the communications are established between the devices, the server can withdraw from the communications.

### CROSS REFERENCE TO RELATED APPLICATIONS

This application claims priority under 35 U.S.C. §119(e) from co-pending U.S. Provisional Patent Application No. 61/490,952, filed May 27, 2011, entitled “METHODS AND APPARATUS FOR PREVENTING CRIMEWARE ATTACKS,” by Graham III, which is incorporated herein by reference and for all purposes.

This application claims priority under 35 U.S.C. §119(e) from co-pending U.S. Provisional Patent Application No. 61/650,866, filed May 23, 2012, entitled “METHOD AND APPARATUS FOR A CYBERSECURITY ECOSYSTEM,” by Kravitz et al., which is incorporated herein by reference and for all purposes.

This application is a Continuation-in-Part and claims priority under 35 U.S.C. §120 from co-pending U.S. patent application Ser. No. 13/096,764, entitled “METHODS AND APPARATUS FOR A FINANCIAL DOCUMENT CLEARINGHOUSE AND SECURE DELIVERY NETWORK,” filed Apr. 28, 2011, by Graham III et al., which claimed priority under 35 U.S.C. §119(e) from each of the four following co-pending U.S. provisional applications: i) U.S. Provisional Patent Application No. 61/330,226, filed Apr. 30, 2010, entitled “CLEARINGHOUSE SERVER FOR FINANCIAL DATA DELIVERY AND FINANCIAL SERVICES,” by Graham III et al., ii) U.S. Provisional Patent Application No. 61/367,574, filed Jul. 26, 2010, entitled “METHODS AND SYSTEMS FOR A CLEARINGHOUSE SERVER FOR DELIVERY OF SENSITIVE DATA,” iii) U.S. Provisional Patent Application 61/367,576, filed Jul. 26, 2010, entitled “METHODS AND APPARATUS FOR A FINANCIAL DOCUMENT CLEARINGHOUSE SYSTEM,” by Graham III et al., and iv) U.S. Provisional Patent Application No. 61/416,629, filed Nov. 23, 2010, entitled “METHODS AND APPARATUS FOR SECURE DATA DELIVERY AND USER SCORING IN A FINANCIAL DOCUMENT CLEARINGHOUSE,” by Graham III et al., each of which is incorporated by reference and for all purposes.

### BACKGROUND

1. Field of the Described Embodiments

The present invention generally relates to the field of securing online sessions. More specifically, the present invention relates to a system and method for authenticating and monitoring and securing the communication paths of two or more parties online so that a higher standard of care for security is achieved during a live session.

2. Description of the Related Art

In computer science, in particular networking, a session is a semi-permanent interactive information interchange, also known as a dialogue, a conversation or a meeting, between two or more communicating devices, or between a computer and user. A session is set up or established at a certain point in time, and ended at a later point in time. An established communication session may involve more than one message in each direction. A session is typically, but not always, stateful, meaning that at least one of the communicating parts needs to save information about the session history in order to be able to communicate, as opposed to stateless communication, where the communication consists of independent requests with responses. An established session is the basic requirement to perform a connection-oriented communication.

Communication sessions may be implemented as part of protocols and services at the application layer, at the session layer or at the transport layer in the OSI model. Application layer examples include HTTP sessions, which allow associating information with individual visitors and a telnet remote login session. A session layer example includes a session initiation protocol (SIP) based Internet phone call. A transport layer example includes a TCP session, which is synonymous to a TCP virtual circuit, a TCP connection, or an established TCP socket.

Many types of sessions can be established in an online networked environment. For example, a person might desire to establish a session with a bank. As another example, an enterprise company might want to establish a session with its customer for the purpose of securely sharing documents in a directory. As another example a person might want to establish a connection with a healthcare provider to review their account. In general, as more and more activities have moved online, individuals are engaging in more and more online sessions of different types as part of their personal and work lives.

Recognizing the growth in online sessions, criminals engaging in financial cybercrime have developed a new class of malware designed specifically to automate cybercrime, referred to as “crimeware.” Crimeware (as distinct from spyware, adware, and malware) is designed (through social engineering or technical stealth) to perpetrate identity theft in order to access a computer user's online accounts as part of a fraudulent session. As an example, crimeware can be used to access financial services companies, online retailers, and other personal accounts for the purpose of taking funds from those accounts or completing unauthorized transactions that enrich the thief controlling the crimeware. As another example, Crimeware can be used to perpetrate theft within a private network, such as logging in to a healthcare provider network, cloud network, government agency, educational institution, or corporate account for the purpose of exporting confidential or sensitive information from a network for financial exploitation. Thus, crimeware represents a growing problem in network security as many malicious code threats seek to pilfer confidential information from unsuspecting users as they engage in online sessions as part of their personal and work activities.

In view of the above, it is desired to provide methods and apparatus for preventing or reducing crimeware attacks. In particular, methods and apparatus for establishing and maintaining secure online sessions are desirable.

### SUMMARY OF THE DESCRIBED EMBODIMENTS

A secure online session system compatible with user-controlled electronic devices, such as desktops, smart phones, netbooks, laptops, tablet computers, smart cards and memory sticks, is described. The secure online session system can include apparatus and method for preventing crimeware. As part of the secure online session system, a secure online session application can be installed on a user-controlled electronic device in order to provide various personal information management services. The secure online application can include one or more of 1) a vault management component that provides secure electronic storage of an individual's or business's valuable documents and other information, 2) a cryptographic key management component that enables mutual authentication of parties participating in a on-line transaction and secure storage/retrieval/sharing of personal information, 3) a secure communication component that allows secure sessions to be establish with remote devices, 4) a user interface component that allows a user to retrieve, view and share documents and other types of information in a simple and a secure manner, 5) a user interface component that allows a user to easily manage a security level related to the storage and transmission of their personal information and combinations thereof.

The secure online session application installed a user controlled device can be configured to interface with a central system. The central system can be configured to enable services related to the secure synchronization of data between multiple devices controlled by a single user, access to user data stored in the cloud (non-user controlled devices) and the secure sharing of data between devices controlled by multiple users. In a particular embodiment, the central system can be configured to act as an intermediary in a communication session where a user can access personal data and/or perform on-line transactions involving a third-party site where the third-party site has access to the user's personal data. In one example, the third-party site can be a financial site, such as banking site that allows a user to view their financial data and perform on-line banking transactions.

In particular embodiments, the central system can be configured to mediate communications between a user controlled device and a third-party controlled device. The mediation can involve an instantiation of two secure communication sessions involving the user-controlled device, the third-party controlled device and the central system. A first communication session can be established between the user-controlled device and the central system and a second communication session can be established between the central system and the third-party controlled device. In one embodiment, the central system can implement a transport layer security (TLS) handshake for the first communication session and the second communication session where distinct and separate encryption keys are established for each session. In addition, the central system can be configured to perform a number of steps beyond the TLS session handshakes that are for allowing each of the parties participating in the sessions to mutually authenticate one another.

In one embodiment, during a mediated communication session, the central system can receive messages from the user-controlled device to the third-party device via the first communication session and receive messages from the third-party device to the user-controlled device via the second communication session where only the central system possesses the encryption keys for both the first communication session and the second communication session. The central system can decrypt data received in the first communication session with the first communication session encryption keys, encrypt the data with the second communication session encryption keys and then forward the data via the second communication session. Further, the central system can decrypt data received in the second communication session with the second communication session encryption keys, encrypt the data with the first communication session keys and then forward the encrypted data in the first communication session. Prior to forwarding the data, the central system can be configured to perform one or more security checks, such as determining whether data received in a message has been correctly signed and whether data integrity has been maintained. When a security check is not successful, the central system can be configured to perform a remedial action, such as not forwarding the data that fails the security check and/or terminating a communication session.

In another embodiment, the central system may simply broker the set-up of the communications between the user-controlled electronic device and the third-party electronic device. The central system can establish communication sessions with the user-controlled device and the third-party electronic device using varying degrees of security and authentication of the parties involved in the communications. Then, the central system can hand off the communications such that communications can continue between the user-controlled device and the third-party electronic device without further involvement from the central system or involving only periodic monitoring by the central system. In one instance, a web browsing session can be established using the communication session brokered by the central system between the user device and the third-party device. In one embodiment, the identifying information about the user and their device may not be revealed to the third-party device during the communication brokering process to allow the user to engage in an anonymous browsing session.

One aspect of the described embodiments can generally be characterized as a method in a server including a processor and memory. The method can be generally characterized as comprising: 1) establishing in the processor a first communication session with a first electronic device; 2) receiving in the processor from the first electronic device a secure browsing request; 3) based upon information included in the secure browsing request, locating in the processor a third-party electronic device hosting a third-party application on a network; 4) establishing in the processor a second communication session with the third-party electronic device; and 5) establishing in the processor a third communication session between the first electronic device and the third-party electronic device wherein the third communication session enables data generated from the third-party application to be received by the first electronic device.

### BRIEF DESCRIPTION OF THE DRAWINGS

The embodiments will be readily understood by the following detailed description in conjunction with the accompanying drawings, wherein like reference numerals designate like structural elements, and in which:

FIGS. 1 and 2 show block diagrams of a mediated communication session involving a client, central server and 3^{rd} party server in accordance with the described embodiments.

FIG. 3A is an interaction diagram showing instantiation of a TLS session between a central server and a client in accordance with the described embodiments.

FIG. 3B is an interaction diagram showing instantiation of a user login session involving a thick client and a central server in accordance with the described embodiments.

FIG. 4 is an interaction diagram showing communications between the thick client and a customer facing security domain at a central server involving secure browsing in accordance with the described embodiments.

FIG. 5A is an interaction diagram showing communications between a thick client, a central server and a 3^{rd} party server where the central server mediates a secure browsing session in accordance with the described embodiments.

FIG. 5B is an interaction diagram showing communications between a thick client, a central server and a 3^{rd} party server where data is sent from the thick client and received in the 3^{rd} party device in accordance with the described embodiments.

FIG. 5C is an interaction diagram showing communications between a thick client, a central server and a 3^{rd} party server where data is sent from the 3^{rd} party server and received in the thick client in accordance with the described embodiments.

FIG. 6 is a block diagram of a server and user computer in accordance with the described embodiments.

### DESCRIBED EMBODIMENTS

In the following paper, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

A central system can be configured to communicate with user-controlled electronic devices, such as controlled by an individual, and third-party controlled devices, such as a server controlled by a bank. Examples of user-controlled device include but are not limited to desktops, smart phones, netbooks, laptops, tablet computers, smart cards and memory sticks. Typically, the third-party controlled devices as well as the electronic devices at the central system will be one or more servers.

The central system can be configured to perform a number of security related functions, such as but not limited to 1) managing electronic vaults that provide secure electronic storage of their valuable documents and other information, 2) managing cryptographic keys, certificates and/or tokens that enable i) mutual authentication of the central system and entities engaging with the central system including individuals and their associated electronic devices and ii) secure communications to be established between the various electronic devices. In one embodiment, the central system can be configured to mediate communications between user controlled devices and/or third-party controlled devices. For example, the central system can mediate individual user to individual user communications, individual user to third-party communications and third-party to third-party communications (i.e., business to business).

In one embodiment, the central system can be configured to mediate communications between a user controlled device and a third-party controlled device. For example, the central system can be configured to act as an intermediary in a communication session where a user can access personal data and/or perform on-line transactions involving a third-party site where the third-party site has access to the user's personal data, such as financial data. The mediation can involve an instantiation of two secure communication sessions involving the user-controlled device, the third-party controlled device and the central system. The communication mediation can also involve mutual authentication of individuals and/or electronic devices engaged in the communications and/or verification of data sent during the communications.

As an example of communication mediation, a first communication session can be established between the user-controlled device and the central system and a second communication session can be established between the central system and the third-party controlled device. Using the two communication sessions, the user-controlled device can send communications to the third-party controlled device or vice versa through the central system. In one embodiment, the first communication session and the second communication session can use different encryptions keys where only the central system knows the communication encryption keys for both first communication and the second communication sessions.

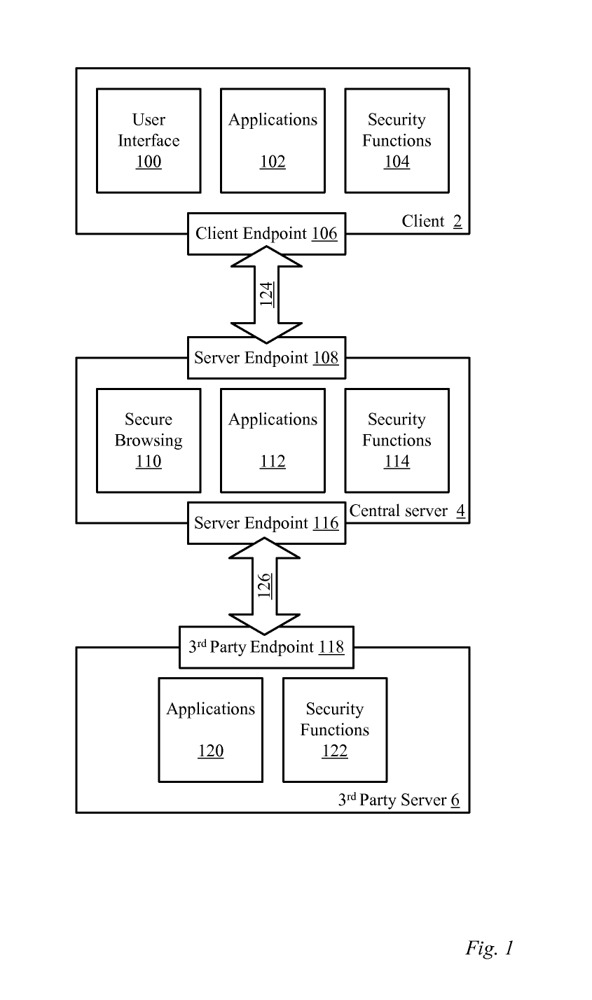

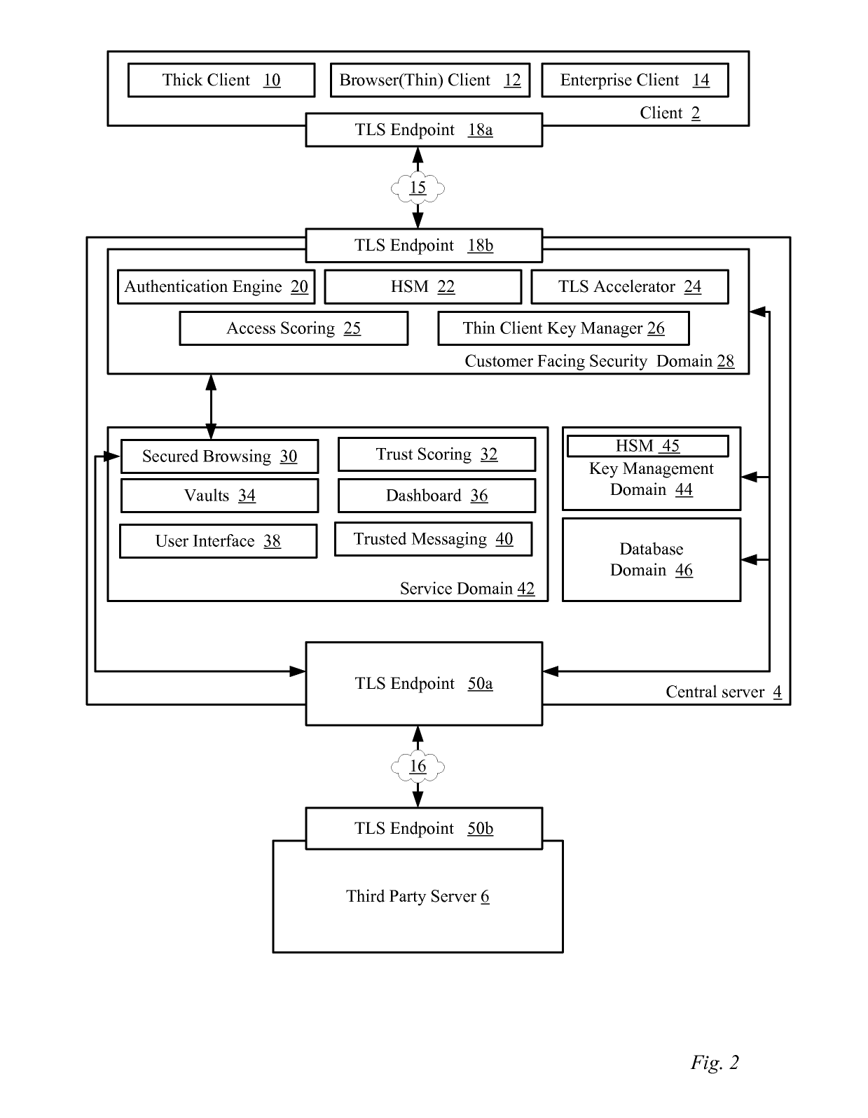

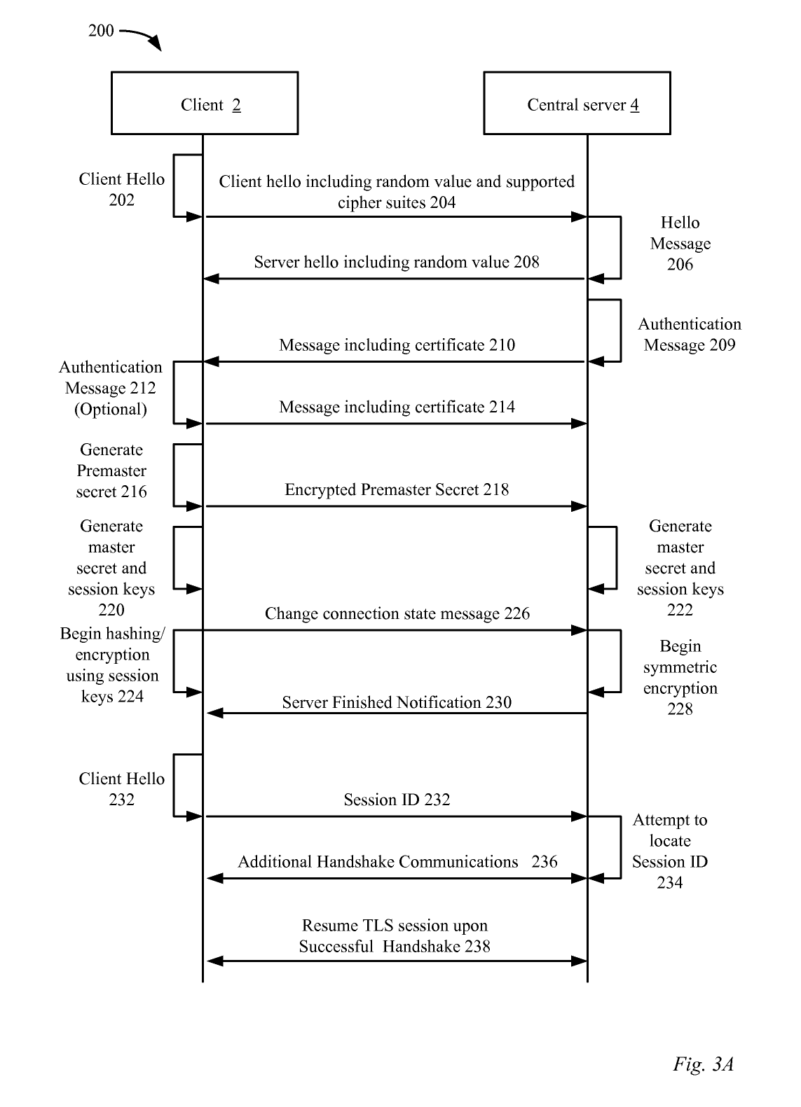

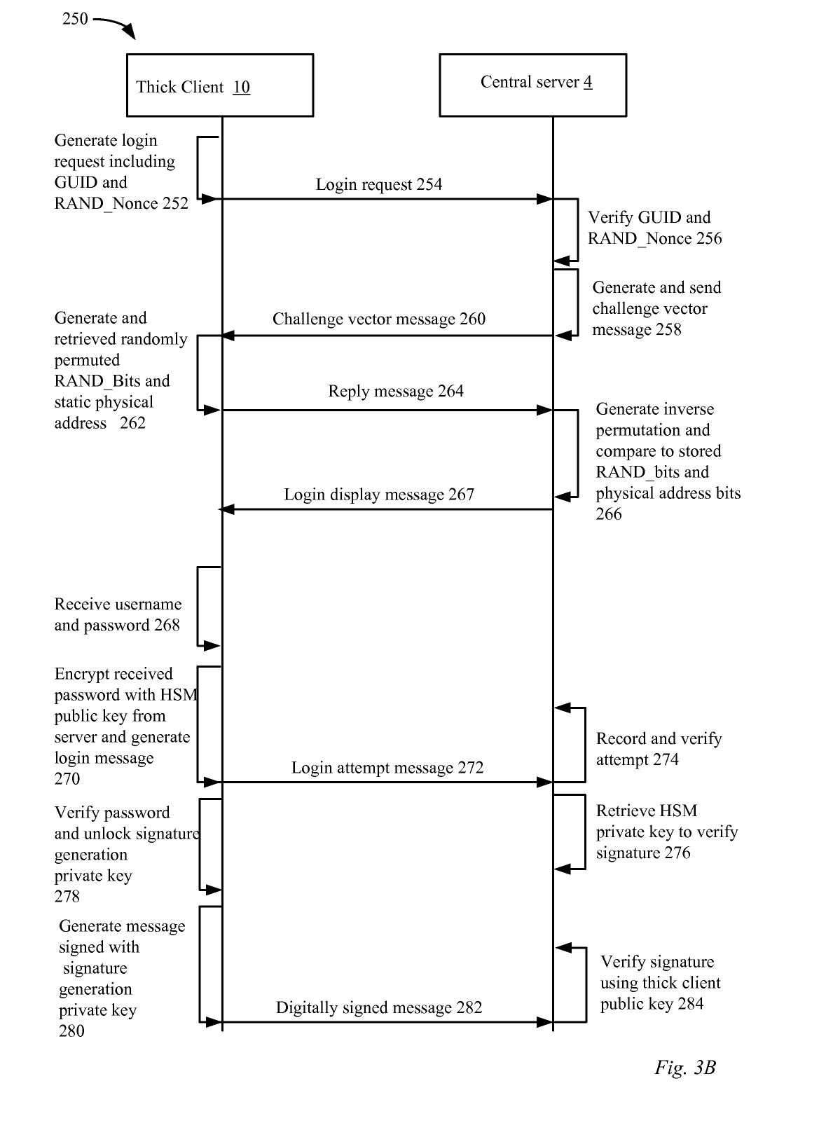

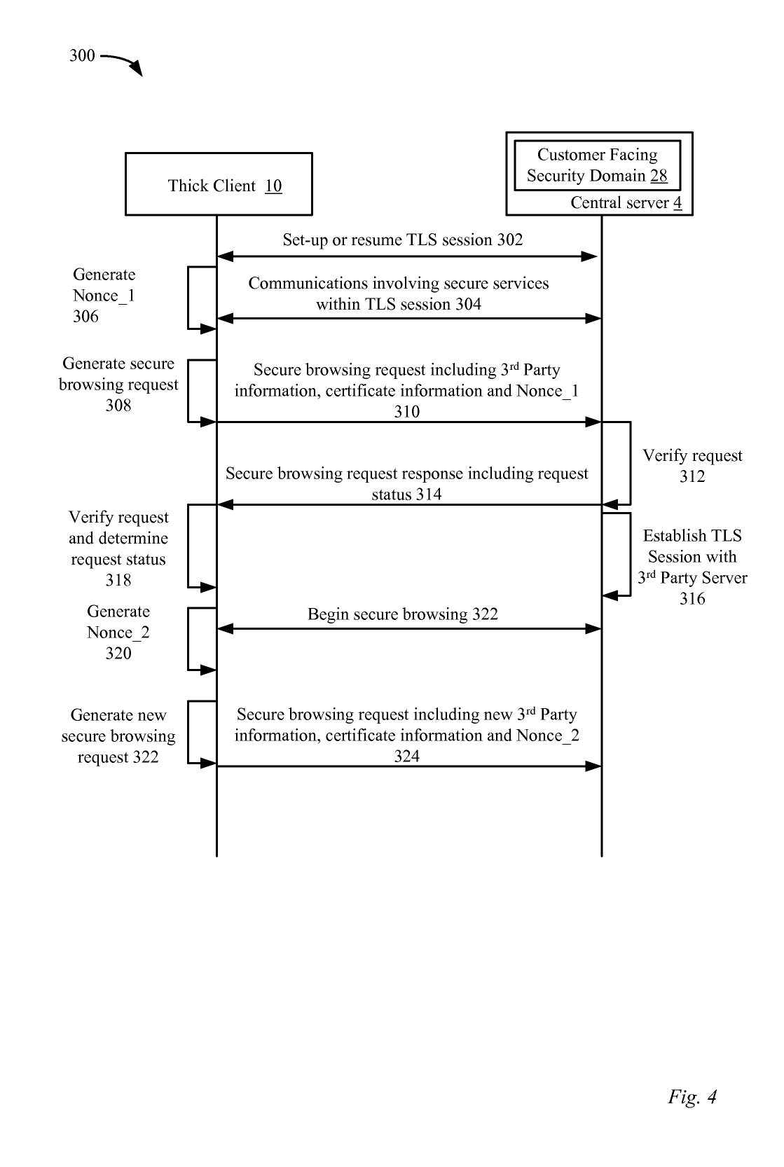

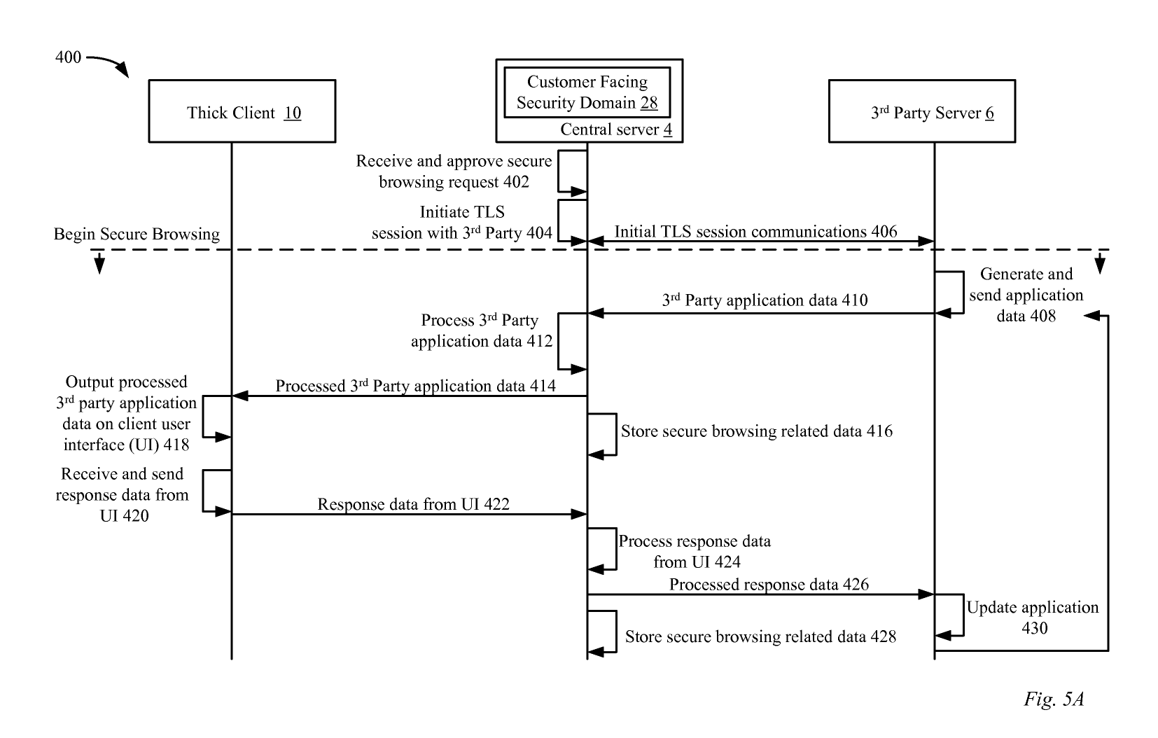

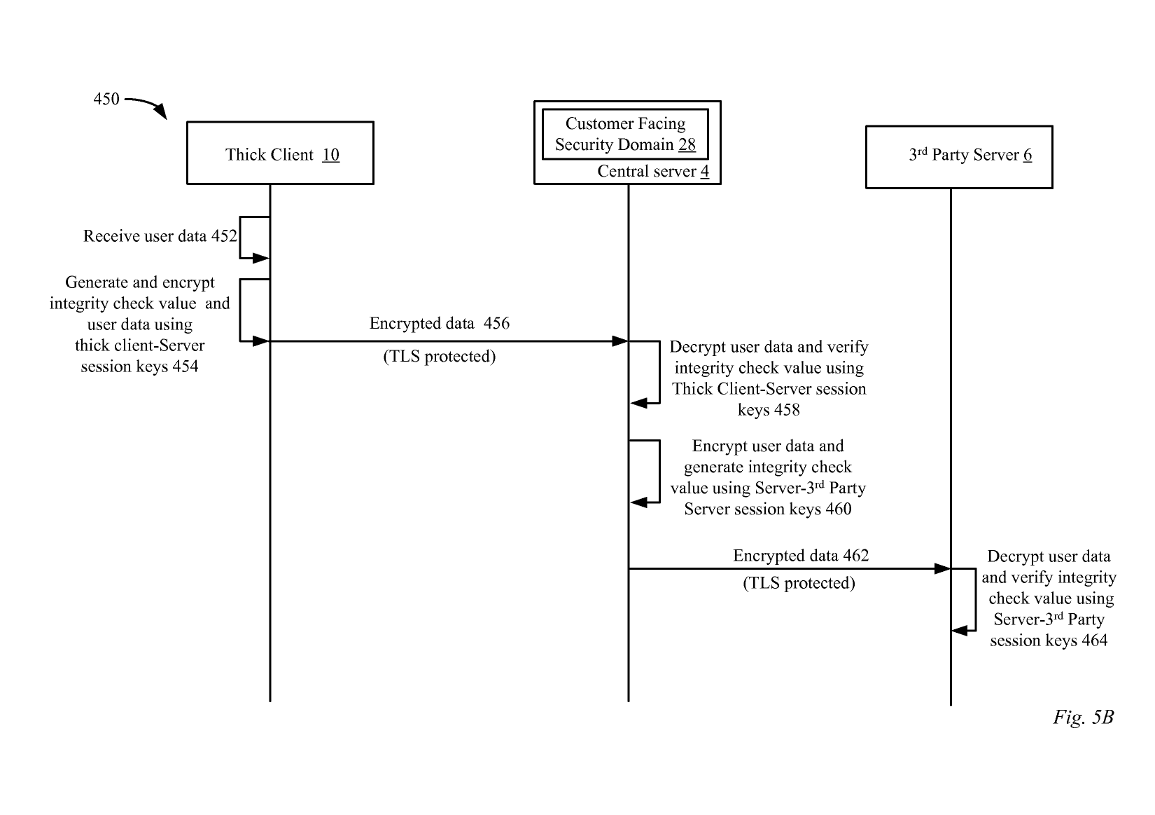

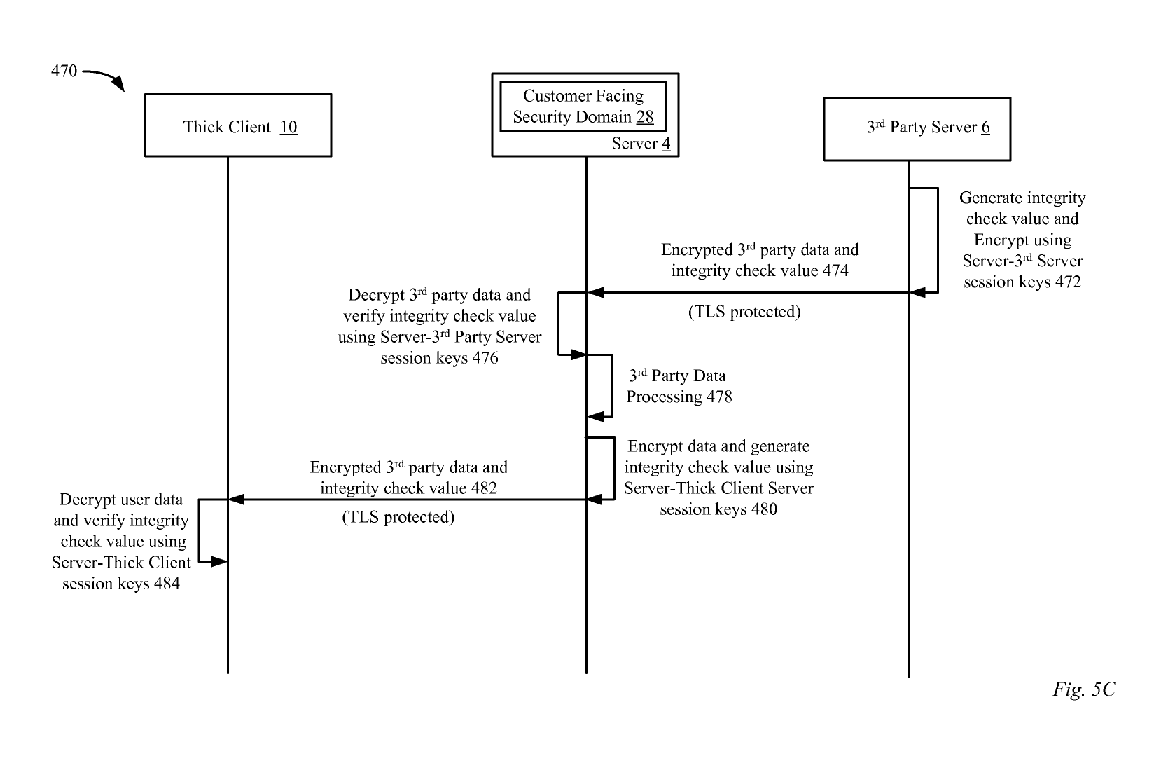

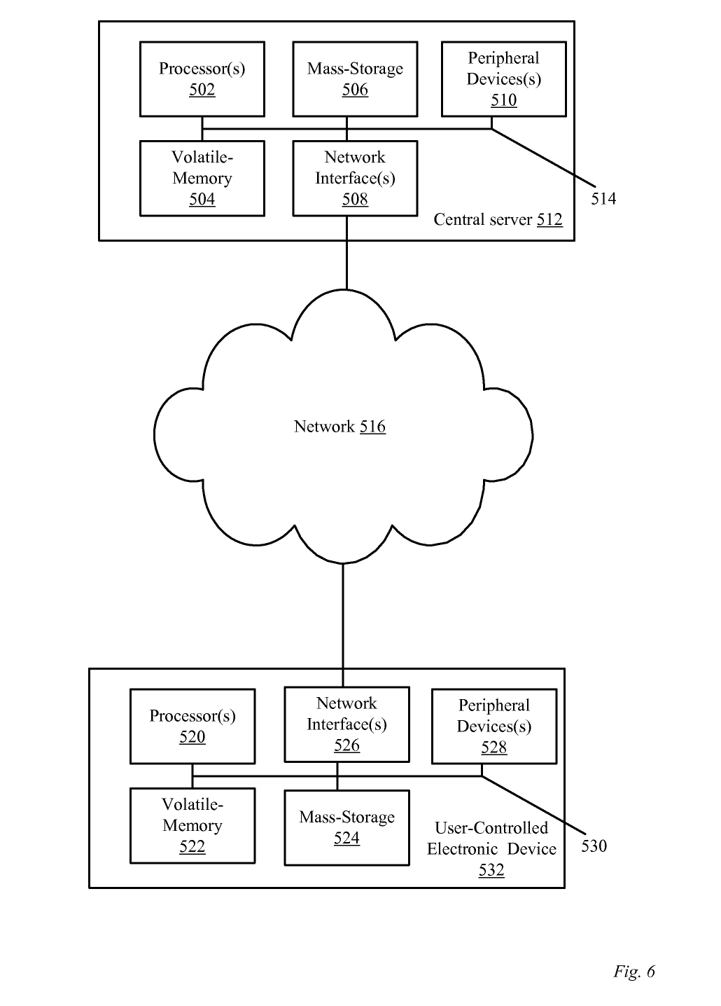

Details of embodiments involving secure communication mediation are described with respect to the following figures. In particular, with respect to FIGS. 1 and 2, a mediated communication session involving a client, central server and 3^{rd} party server is discussed. In particular, with respect to FIG. 2, aspects of the central server that provides the communication mediation are discussed in more detail. With respect to FIG. 3A, an instantiation of a TLS (Transport Layer Security) session between a central server and a client is described. Interactions involving a user login session involving a thick client engaging a central server are discussed with respect to FIG. 3B. In regards to FIG. 4, communications between the thick client and a customer facing security domain at a central server involving secure browsing are described. With respect to FIG. 5A, communications between a thick client, a central server and a 3^{rd} party server where the central server mediates a secure browsing session are discussed. In regards to FIG. 5B, secure browsing communications between a thick client, a central server and a 3^{rd} party server where data is sent from the thick client and received in the 3^{rd} party device are described. With respect to FIG. 5C, secure browsing communications between a thick client, a central server and a 3^{rd} party server where data is sent from the 3^{rd} party server and received in the thick client are discussed. Finally, with respect to FIG. 6, examples of a server and a user controlled device that can be utilized herein are described.

### Communication Architecture

FIGS. 1 and 2 show block diagrams of a mediated communication session involving a client 2, central server 4 and a third-party server 6. The client 2 can be a user-controlled device, such as a smart phone, a laptop or a tablet computer, configured to execute a variety of applications 102. The client 2 can include a user interface 100. The user interface 100 can utilize various input and output devices such that data can be output from the client 2 or input into the client 2 in response to user commands.

In addition, as is described in more detail below, the client 2 can be configured to implement a number of security functions, such as setting up secure communication sessions involving encryption and decryption. As an example, a secure communication connection 124 with an endpoint 106 at the client and an endpoint 108 at the central server 4 is depicted. In one embodiment, as is described in more detail with respect to FIG. 3A, the secure communication connection can be implemented using a Transport Layer Security (TLS) protocol.

The central server 4 can be configured to connect to a number of different clients simultaneously and perform various security functions 114, such as establishing secure communication connections with each of the clients. The central server 4 can execute a number of applications that provide various services to the client devices. One particular application is a secure browsing application. Other examples of applications are described as follows with respect to FIG. 2 and in U.S. patent application Ser. No. 13/096,764, entitled “METHODS AND APPARATUS FOR A FINANCIAL DOCUMENT CLEARINGHOUSE AND SECURE DELIVERY NETWORK,” previously incorporated herein by reference.

The central server 4 can receive a request to mediate a communication connection between a client 2 and a third-party server 6. In response, via the secure browsing application, the central server 4 can establish a secure communication connection with the third-party server 6 that is separate and distinct from secure communication connection between the central server 4 and the client 2 and then begin mediating communications between the third-party server 6 and the client 2. As an example, a secure communication connection 126 with a first endpoint 116 at the central server 4 and a second endpoint at the third-party server 6 is depicted. Additional details of establishing the secure communication sessions and implementing secure browsing are described in more detail below with respect to FIGS. 3A-5C.

The third-party server 6 can implement a number of security functions 122, such as encrypting and decrypting data. In addition, the third-party server can execute a number of applications that are of interest to the user of the client device. For example, the third-party server 6 can be associated with a bank that allows on-line account access to its members. Thus, a banking application can be executed by the third-party server 6 to provide account access to its members. As another example, the third-party server can be associated with a shopping site where a shopping application can be executed to let a user of the client 2 purchase a product.

Next additional details of the central server 4 and some of its security functions are described with respect to FIG. 2. In FIG. 2, a client 2 communicates over a first secure connection over a network 15 with a central server 4. As an example of a secure connection, a TLS connection including a first endpoint 18a at the client 2 and a second endpoint at the 18b at the central server 4 is shown. Some details related to establishing a TLS connection are described as follows with respect to FIG. 3A.

The central server 4 communicates with a third-party device over a second secure connection. In this example, the third-party device is a third-party server 6. In one embodiment, the third-party server 6 may host applications, like a web-site, that accessible to outside entities, such as individuals or businesses. Like the first communication connection, the second communication connection is established using a TLS protocol over network 16. The TLS connection includes a first endpoint 50a at the server and a second endpoint 50b at third-party server 6. In alternative embodiments, other security protocols, such as SSL, can be used to implement the first or the second communication connection.

As described above, communications between the client 2 and the third-party device 6 can be mediated by the central server 4. In one embodiment, an individual user can use the client 2 to manage their personal information where the information management includes one or more of i) accessing personal information on the client 2, ii) accessing personal information on the third-party server 6 or iii) exchanging personal information between client 2 and the third-party server 6. In another embodiment, an individual user can use the client 2 to manage work-related information where the information management includes one or more of i) accessing work-related information on the client 2, ii) accessing work-related information on the third-party server 6 or iii) exchanging work-related information between client 2 and the third-party server 6. The individual may access the work-related information to perform work tasks remotely in a secure manner on a user-controlled device. In yet another embodiment, an individual user associated with a business can use the client 2 to manage business related information where the information management includes one or more of i) accessing business related information on the client 2, ii) accessing business related information on the third-party server 6 or iii) exchanging business-related information between client 2 and the third-party server 6.

In general, the client 2 can communicate with a third-party electronic device. The third party electronic device doesn't have to be a server, such as a server 6. For example, the third-party electronic device can be a smart phone, a tablet computer, a desktop computer or a laptop computer that hosts an application that can be accessed by the client 2 via a network. In one embodiment, the third-party electronic device can be associated with a business, such as a bank. In this example, personal information or business related information that is accessed can include financial data associated with an individual or a business. In other embodiments, as described above, the third-party electronic device can be associated with an individual's work allowing the person to retrieve work related information.

In yet another embodiment, the third-party electronic device can be associated with another individual. For example, an individual selling goods at a farmer's market. The third-party device can host a financial application that allows the individual to sell their goods. The client 2 via the central server 4 can establish a secure communication connection with the third-party electronic device. The central server 4 can provide authentication checks for both individuals and their devices. If the authentication checks are successful, then the client 2 can communicate with an application hosted on the third-party electronic device. The application can be used to implement a transaction between the users.

In FIG. 2, three types of clients, thick client 10, thin client 12 and enterprise client 14 are shown as examples of a client 2 instantiated on a user-controlled device. In general, one or more different clients can be instantiated simultaneously on client 2. For example, thick client 10 can be instantiated on the client 2 to allow a user to manage their personal information whereas enterprise client 14, which can also be a thick client, can be instantiated to allow the user to manage their work related information. Further, the thin client 12 can be instantiated to allow a second user that doesn't have access to the thick client 10 or the enterprise client 14 to manage and/or access their personal information via the client 2.

In general, there are a number of security steps that can be implemented alone or in combination with one another. Conceptually, a thick client, such as 10, will implement more security features as implemented with a thick client, such as 10, as compared to a thin client, such as 12. Thus, “thickness” can refer to increasing number of security steps that are being implemented as part of client.

In one example, a thick client, such as 10, can be defined according to the utilization data that is persistently stored on a user-controlled device on which the thick client is instantiated. For example, the thick client, might be said to be “thick” because it can utilize a Machine Access Control address (MAC) and/or a local key store module (LKSM) for managing private encryption keys as described in more detail below. The private encryption keys can be securely stored and used to digitally sign messages that are used to authenticate the client that sent the message. The “thick” client can be configured to validate user supplied information before the encryption keys are unlocked.

In contrast, a thin client, such as 12, can be instantiated that uses only cookies stored on the user-controlled device. In both instances, the thick client and thin client use persistent data stored on the user-controlled device. However, since in one instance more security steps are required to access the persistent data one client can be said to be “thicker” as compared to the other client. If additional security steps are added, then the client referred to as thick client in this example (i.e., the one that uses an LKSM) can be said to be an even thicker client as compared to a client without the additional security features. Thus, the terms “thick” and “thin” are relative terms that are used for the purposes of discussion and are not meant to limit a “thick” client or a “thin” client to a particular set of fixed security features.

As shown in FIG. 2, the client 2 and the third-party server 6 can each communicate with the central server 4 where the central server 4 can be configured to implement a number services and security functions. For example, in one embodiment, the central server includes 1) a customer facing security domain 28 for implementing a number of security features, such as establishing secure communication connections as described above, 2) a key management domain for securely managing encryption keys, 3) a database domain for securely storing user data in an encrypted format (i.e., cipher text) and 4) a service domain that implements a number of functions that operate on top of the security functions described herein.

A few examples of services that can be provided at the central server 4 include but are not limited to secure browsing 30, trust scoring 32, vaults 34, a user dashboard 36, a user interface 38 and trusted messaging 40. Secured browsing 30 is described in detail herein. Trust scoring 32 can involve making an assessment in regards to a probability that an entity, such as an individual or business, can be trusted to possess the identity that they have claimed. In one embodiment, the trust scoring can involve assessing identification procedures performed by third-parties. Further details of trust scoring that can be utilized herein are described in more detail with respect to U.S. patent application Ser. No. 13/096,764, entitled “METHODS AND APPARATUS FOR A FINANCIAL DOCUMENT CLEARINGHOUSE AND SECURE DELIVERY NETWORK,” previously incorporated herein.

Electronic vaults 34 can be related to securely storing data in a persistent manner on user-controlled device and in the cloud. Trusted messaging 40 can involve securely sending messages between different entities including verifying receipt of the message and verifying the recipient of the message. Details of the electronic vaults 34 and trusted messaging 40 that can be utilized herein are again described in more detail with U.S. patent application Ser. No. 13/096,764.

The dashboard service 36 can be included with the system. One feature of the dashboard can be to reliably display the number and types of “current” access points, such as thick client instances that have been created by a user. “Current” here may refer to access points that the central server 4 is aware of, without indication of which of these is currently online. Although, if the central server 4 determines that the access point is on-line that information can be indicated by the dashboard service 46. In one embodiment, a thick client can be created in combination with a smart peripheral device that needs to be present to initiate the thick client. The dashboard service 36 can distinguish among thick client instances in regards to whether or not a smart peripheral device is required. The dashboard service 46 can also be configured to indicate whether or not a thin client, such as browser client that works with a web-browser to access the central server 4, has been activated.

The user interface 38 can refer to an interface that is provided with a thick or thin client. In one embodiment, the central server 4 can be configured to generate an interface for a thin client. For example, the central server 4 can be configured to generate an interface that allows a user to access the central server 4 and utilize some of its services from web-browser, such as a web-browser executing on a non-secure public computer.

The customer facing security domain 28 can be configured to implement various security features/functions at the central server. For purposes of illustrations, a few examples of security features/functions include but are not limited to an authentication engine 20, a hardware security module 22, a TLS accelerator 24, access scoring 25 and thin client key manager 26. Some details of these components are described as follows.

The authentication engine 20 can be configured to perform various tasks involving authentication of users. In one embodiment, the authentication can involve implementing a challenge-response protocol. For example, a user may want to access a given document only rarely but afford it a higher level of protection. Successful download of the document ciphertext and/or of the document-specific key encrypted using the appropriate encryption public key may require an additional challenge-response protocol, such as correctly answering one or more questions where a user has previously provided the correct answers. The questions that are utilized each time can be randomly selected from a set of questions the user has previously answered. These question-answer sets may be distinct from those used for other purposes such as a password recovery value procedure, and may be managed solely by the authentication engine in the customer facing security domain 28 without involvement of the key management domain 44.

The hardware security module (HSM) 22 can be hardware that resides on the central server 4 to provide additional confidentiality and/or integrity protection for sensitive and/or critical information or operations such as but not limited to i) login credentials, ii) private keys (for asymmetric cryptography) and/or secret keys (for symmetric cryptography), iii) audit trail information and 4) controlled digital signature generation. Using HSM 22, the SSL/TLS sessions can be set up and sensitive information may also be verified. For example, the session keys for the secure connections between the client 2 and the central server 4 and the central server 4 and the third-party server 6 can be generated using the HSM 22.

A key management HSM 45 can be included within the key management domain 44. In the key management HSM 45, user private keys can be generated and managed. PM functionality (such as pertaining to certification authority (CA) and/or registration authority (RA) may also be managed and/or coordinated by the key management HSM 45. Keys high in a hierarchy, such as master keys, may be generated and/or stored within the HSM 22 as well as within the key management HSM 45. Each of the HSM 22 and the Key Management HSM 45 may actually be comprised of a plurality of HSMs, in order to accommodate load and/or backup. Although HSM 22 and HSM 45 are shown in FIG. 2 as separate components, under proper controls and partitioning, some aspects of these may be present in a single physical device.

SSL/TLS acceleration is a method of offloading the processor-intensive public key encryption algorithms involved in SSL/TLS transactions to a hardware accelerator (one or more SSL/TLS accelerators, such as 24). For example, a separate card that plugs into a PCI slot in a computer that contains one or more co-processors can be used to handle much of the SSL/TLS processing. SSL/TLS accelerators may use off the shelf CPUs, but most use custom ASICs and RISC chips to do most of the difficult computational work. Although the TLS accelerator 24 and HSM 22 are shown in FIG. 2 as separate components, the SSL/TLS acceleration may be managed by an HSM, such as 22.

The most computationally expensive part of an SSL or TLS session is the SSL or the TLS handshake, where i) the SSL or TLS server, such as central server 4, and the SSL or TLS client, such as client 2, or ii) the SSL or TLS server, such as the third-party server 6, and the SSL or TLS client, such as central server 4, agree on a number of parameters that establish the security of the connection (Depending on whether it is initiating the handshake or not, the central server 4 can be in the client role or the server role in the handshake process). Part of the role of a SSL or TLS handshake is to agree on session keys (symmetric keys, used for the duration of a given session). A TLS handshake is described as follows with respect to FIG. 3A.A hardware SSL or TLS accelerator, such as 24, may offload processing of the SSL or TLS handshake while leaving the server software to process the less intense symmetric cryptography of the actual SSL or TLS data exchange. However, some accelerators can handle all of the SSL or TLS operations and terminate the SSL or TLS connection.

Access scoring 25 can involve assessing the security of an access point that is being used to communicate with the central server 4. The access scoring 25 can be configured to generate a score. The access score can characterize the security risk for a user in a specific online session. Thus, the access score can vary from session to session.

In one embodiment, the access score can be a number calculated using a specified algorithm that weights various security elements of a user's access platform. Verbal descriptors, such as high security access point or low security access point can also be used in conjunction with or separate from a numerical access score. In one embodiment, the access score can be generated using a proprietary algorithm. The current access score for a session may also take into account the score history and the way the user is currently using the system. For example if they always/typically use highest security settings, or always login in a non-secure way, the access score can be configured to reflect an atypical access behavior, such as a history of accessing the system securely followed by accessing the system in a non-secure way. In one embodiment, the system can be configured to make suggestions that improve a user's access score, such as logging in from a more secure platform.

A score or scores generated from the trust scoring 32 and the access scoring 25 results can offer consumers a simple method to customize their encryption, interpret risk, evaluate other members, and to accomplish an appropriate standard of care for the security they wish to apply to either a document or a particular vault. For example, the system can be configured to allow a user to select a trust score, an access score or combinations of a trust score and access score thresholds that affect their interactions with other users on a user-by-user basis. Via the threshold selections, a user can tune the level of security that is being provided. In one embodiment, a composite score can be generated that simultaneously accounts for both trust score and access score results. Again, thresholds can be selected for the composite score that allow the user to tune the security that is provided. For example, a first user can select a composite score threshold that a second user must meet before engaging with the first user. Such engagement need not be direct, e.g., it may be in the form of sourcing and receiving a document without requiring a first user and a second user to overlap their system login sessions.

### Secure Communication Connections for Mediated Communications

In this section, methods and apparatus for establishing secure communication connections that can be used in a mediated communication session are described. The mediated communications can involve communications sent between user-controlled devices and a 3^{rd} party server as mediated by a central server. The instantiation of mediated communications can involve setting up a secure communication session between the central server and each of the participating devices. In one embodiment, as is described in more detail as follows with respect to FIG. 3A, a Transport Layer Security (TLS) protocol, such as a TLS protocol 3.0 can be utilized for the secure communication session. Then, before a user is allowed to login at a 3^{rd} party server, such as a server hosting a banking application, attempts can be made to mutually authenticate each of participants involved in the communications.

FIG. 3A is an interaction diagram showing instantiation of a communication session between a central server 4 and a client 2 that uses a TLS protocol. Other security protocols, such as Secure Sockets Layer (SSL) can be utilized. Thus, the example of TLS protocol is provided for the purposes of illustration only and is not meant to be limiting.

In TLS, a relationship is established between two parties, such as client 2 and central server 4 or a central server 4 and a 3^{rd} party server, by using a handshake exchange. The handshake exchange can involve a series of messages sent between the two devices in a particular order. Details of these messages are described as follows.

At the start of the handshake, the two parties can exchange hello messages. For example, client 2 generates a hello message in 202 and sends the message 204 to the central server 4. After receiving the hello message 204, the central server 4 can process the hello message and generate a reply hello message in 206. TLS is not symmetrical, so one party must take the role of the server and the other the client. Typically, the client device sends the first hello message.

The client hello message 204 can contain a list of the cipher suites and compression methods that the client 2 can support. In 204, the client can indicate which ones it supports, in order of preference. In addition, the Client Hello can include a random number, called ClientHello.random, which can be any value but is selected to be completely unpredictable to everyone (except the client). This random number can be used to generate liveness.

In more detail, a cipher suite can be a combination of cryptographic methods used together to perform various security tasks. For a network connection using TLS or SSL network protocol, the cipher suite can be used to define the type of certificates, the encryption method, and the message authentication code algorithms used to negotiate the security settings. In more detail, each named cipher suite may define a key exchange algorithm, a bulk encryption algorithm, a message authentication code (MAC) algorithm and a pseudorandom function. The key exchange algorithm is used to determine if and how the client and server will authenticate during the handshake RSA, Diffie-Hellman, ECDH, SRP, PSK are examples of key exchange algorithms. The bulk encryption algorithm is used to encrypt the message stream. It can include the key size and the lengths of explicit and implicit initialization vectors (cryptographic nonces). RC4, Triple DES, AES, IDEA, DES, or Camellia are examples of bulk encryption functions. The message authentication code (MAC) algorithm is used to create the integrity check value, based on a cryptographic hash of each block of the message stream. MD5 or one of the SHA functions are examples of cryptographic hash functions that can be used within a MAC algorithm, i.e. a keyed hash algorithm such as HMAC, Hash-based Message Authentication Code.

The pseudorandom function (PRF) can used to create the master secret, such as a 48-byte secret shared between the client 2 and central server 4 in the connection. The master secret is used as a source of entropy when creating session keys, such as the one used to create the MAC. The guarantee of a PRF is that all its outputs appear random, regardless of how the corresponding inputs were chosen, as long as the function was drawn at random from the PRF family. Further details of TLS including cipher suite combinations are described in more detail with respect to “RFC 5246,” “ RFC 5077” and “RFC 4492.”

As described above, a random number can be generated to ensure “liveness.” In a secure exchange, it is desirable to know that the negotiation is live and a recording of a previous exchange is not being used. Generating and incorporating a different number with each session makes it much harder to use recorded data in an attack. A truly random number has the disadvantage that there is a small probability that the same value will occur twice. A number that is guaranteed never to be used again or that has sufficient randomness to render the chance of a repeat as probabilistically insignificant is called a nonce. In the previous paragraph, the random number is an example of nonce used to generate liveness.

After the central server 4 receives the client hello message 204, in 206, it can check that it is able to support one of the chosen cipher suites and compression methods. If it doesn't, the client 2 can be notified and the instantiation of the secure communication session may be terminated. If it does, the central server 4 can generate and reply with a server hello message 208. The server hello message can include another random number, called ServerHello.random, which is different from the client's random value. In addition, it can include a session ID that the client and server use to refer to the TLS communication session. The session ID can be stored by the server to later identify the communication session if it is subsequently removed.

One of the features of TLS is that a security session, once established, can be resumed multiple times by the client indicating current session ID in the client hello message. An example of a client resuming a session is described below with respect to 230 and the steps that follow. In one embodiment, the session ID can be configured to expire after a time period after which a new handshake and session ID are generated. In another embodiment, the session ID can be configured such that it can be used some maximum number of times after which it is no longer valid, such as five times.

During the handshake both the client 2 and the central server 4 can be configured to store all the messages they have sent or received. For example, client 2 can store message 204 and central server 4 can store message 208. At the end of the handshake, the client 2 and the central server can be required to prove that they have these copies to help ensure that no one has altered or inserted any messages during the instantiation process.

Next, the client and server can exchange certificates. If the session is being resumed, this exchange may be skipped. In 209, the central server 4 can generate an authentication message including its certificate. In 210, the server sends its certificate to the client 2. The certificate can include the name and public key of the server. These can be used to encrypt messages to the server and validate signed messages from the central server 4.

The certificate can be signed by a certificate authority to prove that it is authentic. After receiving the central server's certificate, the client 2 can validate the certificate using the certificate authority's public key and then store the server's public key to encrypt further messages to the central server 4. As part of an attack, it is possible a valid copy of the server's certificate can be copied and sent by another device to the client 2. However, the attacking device would not subsequently be able to decrypt the correct pre-master secret because it does not have the secret part of the public/private key pair.

Next, the central server 4 may require the client to send a certificate. Traditionally, for Web browsing applications, it is unusual for a client certificate to be used. Thus, this step may be optional. In one embodiment, in 212, the client 2 can generate a message including its certificate and send it to the central server 4 in 210. The central server 4 can receive the message validate it with the certificate authority's public key in certificate and store the client's public key to encrypt further messages to the client.

The fact that the client 2 has produced a certificate may not prove anything because it could have easily been copied from a previous session. For example, a bogus server in a phishing attack could have requested the client to send its certificate to the bogus server. Then, the bogus server could pose as the client using the certificate it received from the valid client as part of a crimeware attack.

After the central server 4 receives the client certificate or prior to its reception if the client certificate is not requested, the initial phase of the TLS communications can be completed. Towards this end, the central server 4 (not shown) can send the client 2 a server hello done message and wait for the client 2 to initiate the next step. Next, the client 2 and the central server 4 can enter into a next phase of the TLS communication set-up where a mutual secret is established.

The objective of the next phase in the communications is to establish a mutual secret between the client 2 and the central server 4. The mutual secret can be called the master secret. This key binds together the random numbers that were exchanged in the hello messages in 204 and 208 with a secret value that is created dynamically and assumed to be known only by the two parties (the client 2 and the central server 4).

The random numbers (nonces) sent during the hello phase in 204 and 208 may be seen by anybody monitoring the link between the client 2 and central server 4 because they are exchanged in the clear and not encrypted. By contrast, the random value created at this stage is known as the pre-master secret to reflect the fact that it is secret and will be used to generate the master key. One way to generate the pre-master secret and get it securely to both the central server 4 and the client 2 is to take advantage of the server's certificate. The client 2 can generate a random number (such as, 48 bytes) and can encrypt it using the server's public key obtained in 210. Then, the client 2 can send it to the central server 4 using a client key exchange message. The central server 4 can decrypt the random number with the private key and, then both sides have the pre-master secret.

In 216, the client 2 can generate the nonce (random number) and send it encrypted as the pre-master secret to the central server 4 in 218. The incorporation of the random numbers in the messages exchanged between the client 2 and the central server 4 again ensures liveness so that no one can successfully use a recording of a previous exchange. The quality of the random number generator on both sides needs to be high. Some so-called random numbers generate a random distribution of numbers, but in an entirely predictable way. For example, the Rand( ) function in many programming languages always produces the same “random” sequence after initialization. For security purposes, the random number should be unpredictable even after reinitialization.

If the client 2 sent a certificate in 214, a process can be carried out to prove that it is the legal owner of that certificate. In one embodiment, the client 2 can authenticate itself by hashing together all or a portion of the messages received up to this point including both the ones sent and the ones received. The portions to use can be specified in a message sent from the central server 4 to the client 2.

In one embodiment, the client 2 can hash the identified portion of the messages using a previously specified hash algorithm, such as the algorithm specified in 204. The client 2 can send the result to the central server 4 and sign the message with the secret key associated with the certificate it sent to the central server 4 in 214 where the public key associated with the secret key was included in the certificate. The central server 4 can receive the message and can check the signature using the client's public key as delivered in the client's certificate.

When the signature checks out, the central server 4 can compute the hash of messages using the same algorithms used by the client 2 and can check that the result matches what was received from the client. When the signature or the hash check fails, the central server 4 may assume that the client is bogus and take a remedial action, such as terminating the session or reinitializing the session. When the results check out, the server can assume the client at least knows the secret key for the certificate.

The successful comparison doesn't guarantee that the client is not fraudulent but only that the client knows the secret key associated with the certificate. When the client manages the secret key in an unsecure manner such that it can be easily learned by another entity, the benefits of carrying out this authentication procedure may be significantly reduced. In some of the embodiments described with respect to the following figures (e.g., FIG. 3B), a thick client is described that implements strong security features for protecting its secret keys. The security features can be implemented as part of a local key store management component provided on the thick client as part of a security application installed on the thick client.

Returning to FIG. 3A, in 220 and 222, the client 2 and the central server 4 can each generate the master secret and encryption keys to be used during the TLS communications session. Each of the client 2 and the central server 4 each possess shared information, such as the pre-master secret, a nonce generated by the client 2 and a nonce generated by the central server 4. Using the shared information, the client 2 and the central server 4 can each independently combine the values by hashing to produce a master key, such as a 48-byte (384-bit) key. When both devices have the same shared information and use the same algorithms, they will produce the same encryption keys to use for the session. If the same encryption keys are not created, then the follow-on communications between the devices will not be successful.

In the example shown in FIG. 3A, a current state and a pending state can be defined. After initialization, the current state is “no encryption.” Then, information is exchanged and authentication procedures are carried out to create a new pending connection state that is ready to be turned on when all the keys and other required information have been established that are necessary for encrypted communications. In 220 and 222, the master key that has been separately generated by each device can be used to initialize the pending state according to the cipher suite in use. The method used to generate the keys can vary from cipher suite to cipher suite. For example, the cipher might not need all 384 bits of the master key or may derive different keys for receive and transmit, which it can do by further hashing the master key.

Thus, once the master key is established, both the client 2 and the central server 4 can fully set up the pending connection state and then switch it to become the current state. When the switch is performed in TLS, each side sends a change connection state message to the other. In 224, the client 2 can begin keyed hashing and encryption using the generated session keys and in 226 send the change connection state message to indicate it is using the new keys. In 228, the central server 4 can receive the message and respond using a symmetric encryption key determined according the cipher suite. In 230, the central server 4 can send a notification message to the client indicating it is now engaging in the encrypted communications specified according to the cipher suite. The finished message can contain a hash value covering the new master secret and all/or a portion of the handshake messages that have been exchanged from the hello message up to but not including the finished message. When the message is received correctly, the new cipher suite can be considered operational.

As described above, the handshake procedure involving the exchange of certificates doesn't have to be repeated each time. In some instance, a secure communication session, such as TLS session, can be resumed without repeating all of the process. For example, in 232, the client can send a hello message including the session ID previously established in the steps above. In 234, the central server 4 can attempt to locate the session ID. The central server 4 may store a table of valid session IDs which the central server 4 may use to determine whether the session is valid. When the session ID is located, the server and the client can skip from the hello message to the finished messages. The central server 4 and the client 2 can generate a new master key from new random numbers exchanged in the hello messages and generate new symmetric encryption keys valid for the resumed session and begin again securely communicating in 238. The new random numbers can again be exchanged to ensure liveness.

Next, with respect to FIG. 3B, a method involving a login procedure from a thick client is described. The thick client can include a local key store module (LKSM) for protecting its secret keys. As described above with respect to FIG. 3A, the value of the authentication procedures derived from the central server 4 receiving the client's certificate can depend on how securely the client's secret keys are secured. In some of the embodiments described herein, the LKSM and methods for accessing it can be based upon a security application installed on a particular user-controlled device. For the purposes of illustration, this combination can be referred to as a thick client.

FIG. 3B is an interaction diagram showing instantiation 250 of a user login session involving a thick client 10 and a central server 4. The central server 4 can include a customer facing security domain 28 including an HSM as described above with respect to FIG. 2. In 252, in response to a user input, the thick client can generate a nonce (RAND_NONCE) and include it in a login request message. In 254, the login request message can be sent to the central server 4.

The login request message can include a Globally Unique ID (GUID). The GUID may be static information. In one embodiment, the GUID can be used to distinguish between different instantiations of thick clients. When a security application is installed on a client, the software associated with the security application may be universal. However, when it is downloaded to the client, such as from central server 4, download-specific values can be supplied.

The download specific values may be used to uniquely identify the specific instantiation during subsequent communications. This process may have occurred before the login request is attempted. Examples of values that can be downloaded include but are not limited to one or more of a GUID, a first random number (RAND_NONCE), a second random number (RAND_POSN), a third random number (RAND_BITS), a fourth random number (SEED). The first random number (RAND_NONCE) can be generated as part of a liveness check. The fourth random value (SEED) can be used in randomization by the thick client 10.

The second random number (RAND_POSN) can be used to inform the thick client 10 of where to position/hide information in a memory associated with the user-device and/or how to operate on randomly generated values supplied by the third random number (RAND_BITS). In addition, it can specify how to operate on one or more locally available values that can represent a persistent state associated with the user-controlled device. One example of locally available values that can represent a persistent state on a device can be static physical address bits, such as a media access control (MAC) address. RAND_POSN can be deleted from the thick client 10 as soon as it has been used by the thick client. RAND_NONCE, RAND_POSN and RAND_BITS can be updated and synchronized upon each successful online login of the thick client 10 with the central server 4 or even periodically during communications.

RAND_BITS can be randomly generated at the central server 4 and sent to the thick client 10, such as when the thick client 10 is first instantiated. Thus, RAND_BITS can be used to distinguish between different instantiations of thick clients. The thick client 10 can spread the RAND_BITS throughout the user-controlled device on which the thick client is instantiated. In one embodiment, all or a portion of the RAND_BITS can be distributed to a USB or other potentially removable media. For subsequent sessions, the removable media may have to be present to successfully instantiate the thick client.

The spreading of RAND_BITS can be done on the basis of another randomly generated vector denoted by RAND_POSN that describes what positions, files, processes, etc. into which each element of RAND_BITS is to be embedded. RAND_POSN may also detail how/where the physical address (e.g., media access control address of the user controlled device) is to be embedded. Other unique identifiers associated with a user-controlled device can be embedded separate from or in addition to a media access control address which is provided for the purposes of illustration only.

As is described below in 258, 260 and 262, the retrieval process challenge may include only a “lite” form of the RAND_POSN vector. Thus, there is no way to distinguish on the thick client 10 which of the bits in the correct response correspond to RAND_BITS and which correspond to the unique device identifier (e.g., the media access control address). This approach can prevent a successful live substitution of the media access control address in response to a challenge by the central server.

In 256, the central server 4 can receive the login request message. In one embodiment, the login request message can be sent unencrypted. Further, in 256, the central server 4 can attempt to verify GUID and RAND_NONCE. For example, the central server 4 may attempt to determine whether GUID can be found in records of thick client instantiations that have been previously been authorized. When the GUID and RAND_NONCE are successfully verified, in 258, the server can generate a challenge vector and send it in a challenge vector message in 260. In one embodiment, the challenge vector message may only be sent when GUID and RAND_NONCE are verified.

In particular embodiments, as described above, the challenge vector can include a randomly generated permutation of RAND_POSN referred to as RAND_POSN_lite. The inverse permutation can be used when the challenge response is received. This approach can be used to thwart successful substitution of static physical address bits when the client responds to the challenge vector in 262. When RAND_POSN is not known, a malicious program will not be able to operate on the previously hidden information and hence knowledge of persistent information, such as the static physical address bits previously used, will not be sufficient to successfully reply to the challenge received from the central server 4.

Neither the permutation mapping nor its inverse is made available to the thick client 10. The thick client 4 retrieves RAND_BITS and the static physical address bits (although in an unknown permuted fashion according to RAND_POSN_lite where the number of bits that are retrieved can be less than the total number of RAND_BITS). This forms part of the response from the thick client 10. The inverse permutation is applied by the central server 4. The result is compared against the central server's stored version of RAND_BITS and against the determination of the current physical address of the user-controlled device supporting the thick client.

As an example, suppose the original RAND_POSN vector is {15, 8, 35, 42, 3, 7, 10, 6, 5} which meant that rand_bit1=0, rand_bit2=1, rand_bit3=0, rand_bit4=1, rand_bit5=0, physical address bit1, physical address bit2, physical address bit3, physical address bit 4 were to be “hidden” at position { 15, 8, 35, 42, 3, 7, 10, 6, and 5}. The bits can be hidden at the thick client 10 specifically and/or user controlled device in general (where the “hiding” process may be detailed in some sort of policy that has been made available to or is part of the thick client). The RAND_Bits vector may vary in length each time and, in this case was of length 5. Suppose the randomly generated permutation is {1 to 9, 2 to 5, 3 to 3, 4 to 6, 5 to 8, 6 to 7, 7 to 1, 8 to 4, 9 to 2} which implies the inverse permutation is {1 to 7, 2 to 9, 3 to 3, 4 to 8, 5 to 2, 6 to 4, 7 to 6, 8 to 5, 9 to 1}. Then RAND_POSN_lite vector is {10, 5, 35, 6, 8, 42, 7, 3, 15}. Suppose that the original physical address was 1, 0, 1, 1. The thick client 10 would return physical address bit2, physical address bit4, rand_bit3, physical address bit3, rand_bit2, rand_bit4, physical address bit1, rand_bit5, rand_bit1 (i.e., 0, 1, 0, 1, 1, 1, 1, 0, 0), which the central server 4 inverts (resulting in 0, 1, 0, 1, 0, 1, 0, 1, 1) in order to do the comparison.

In 262, the thick client can generate the retrieved randomly permuted RAND_BITS and static physical address bits according to RAND_POSN_lite vector and send a reply message. The contents of the RAND_POSN_lite vector and the number of bits that are to be operated upon can vary each time RAND_POSN_lite vector is generated. In 264, the retrieved information can be sent to the central server 4. In 266, the central server 4 can generate inverse permutation of the component of reply message that purportedly is comprised of randomly permuted RAND_BITS and static physical address bits. Based upon the results of the inverse permutation, the central server 4 can compare the result to the stored RAND_BITS and the current independent determination by central server of the static physical address bits associated with user-controlled device on which the client 10 is implemented. When there is a match, in 267, a login display message can be sent from the central server 4 to the thick client 10.

If there is not a match, then a remedial action can be taken. For instance, the central server 4 may not authorize the thick client 10 to display a login message and the connection may be terminated. Further, the central server 4 can log some record of the failed communication. In one embodiment, the central server 4 can request the thick client 10 to resend its response to the challenge vector.

In 268, the client can generate and display a login interface. In one embodiment, the login interface can enable a user to at least specify a login name and an associated password. In other embodiments, the login interface can allow a user to specify additional information, such as biometric information. In one embodiment, the login interface may allow a user to type a user name and password. In other embodiment, the user may be able to speak their login name and password where the login interface can be configured to recognize their speech. Thus, in 268, via the login interface, the thick client can receive a user name and a password.

In 270, the username and 1^{st} function of the password are encrypted under HSM encryption public key as well as under TLS session keys (see, HSM 22 in the customer facing security domain CFSD 28 in FIG. 2). In one embodiment, the encryption under the HSM encryption public key involves generating a nonce, such as RAND_NONCE, so as to thwart successful server insider replay attack if the freshness of RAND_NONCE values is monitored by the HSM 22 or if the HSM 22 issues a nonce live each time. The live nonce case can be compatible when a thin client login is used as well.

The 1^{st} function of the password can be the result of applying a non-invertible function to the password. For example, a one-way function such as one of the SHA (Secure Hash Algorithm) functions can be applied to the password to generate the 1^{st} function of the password. The 1^{st} function can be one of multiple functions generated for the password. This approach is consistent with the principle of “least privilege” whereby a process that has a legitimate need to at least temporarily access a function of the password may have no need to also access other functions of the password used for other purposes. The use of different functions of the password for different purposes can have a number of security advantages, such as to isolate access types and prevent unauthorized or untimely access to keys or sensitive data.

In 272, the login attempt message can be sent to the central server 4. The message can be signed with the thick client private key. In 276, the central server 4 can retrieve the thick client public key to verify the signature. Further, the central server 4 can verify the “liveness” of the nonce. Then, the central server 4 can record and verify whether the attempt was successful in 274. The central server 4 can keep track of the number of attempts. In one embodiment, when the number of unsuccessful attempts exceeds a particular threshold, all or a portion of the local key store module (LKSM) on the thick client 10 can be over-written or deleted.

In 278, when the [Username, 1^{st} function of Password] are acceptable within allotted number of tries then the signature generation private key within the LKSM can be unlocked. Then, in 280, ensuing messages can be generate and digitally signed using the signature generation private key that has now been unlocked within the LKSM. In 282, a message signed with the signature generation private key has been generated and sent to the central server 4 from the thick client 10. The message is also encrypted using the TLS session keys that have been previously established.

In 284, at the central server 4, the message can be decrypted using the TLS session keys and the signature can be verified using the signature verification public key. The corresponding signature verification public key may have been established at the customer facing security domain (see CFSD 28 in FIG. 2) and the key management domain (see 44 in FIG. 2) as part of thick Client key provisioning previously performed at the server. Besides the signature, each of the digitally signed requests may include a nonce that has been provided by the central server 4 to assure the server that the request is fresh, i.e., it is not a replay of a request from earlier in the session or from a previous session.

### Secure Browsing

In this section, method and apparatus for enable secure on-online interactions are described. An example of an on-line interaction can involve a person navigating to an on-line bank site, logging into their account at the bank and then performing on-line transactions involving their banking account, such as viewing balances, paying bills and transferring funds among accounts. The security methods described herein can be applied so that the chances of a “crimeware” attack and other malicious attacks are greatly lessened.

The term browsing is typically used to describe a scenario where a first electronic device, such as tablet computer, is used to accesses a network, such as the Internet, and then establish a communication with a second electronic device, such as server. The second electronic device can host a web-site application. The web-site application on the server can generate instructions, such as in a mark-up language (e.g., HTML5), which are sent from the second electronic device to the first electronic device via the network. An application executing on the first electronic device, such as a web-browser application, interprets the instructions to allow an interface to be generated on the first electronic device. Typically, the interface can involve a visual component, such as a component output to a display screen. In general, interfaces can involve visual, audio and tactile components (e.g., vibrations).

The interface on first electronic device can be configured to accept inputs. For instance, input devices that can be used as part of a user interface (UI) include but are not limited to a keyboard, a touchscreen, a mechanical button, a microphone that accepts voice inputs, a image capture device (e.g., a camera) or sensors (e.g., tilt or movement sensors). In some instances, the inputs can be interpreted locally by the application on the first electronic device to immediately change the interface, such as an appearance of a visual component of the interface. For example, as a user inputs textual input, it can be displayed locally on the first electronic device as it is accepted by the first electronic device.

In other instances, all or a portion of the inputs can be sent to the second electronic device. For example, a person can enter a login name and password via the interface on the first electronic device which can be sent to the second electronic device via the established network connection. The second electronic device can process the inputs and then generate new instructions which are sent to the first electronic device which cause the interface on the first electronic device to change. For example, the second electronic device can first send instructions for a login page to be generated on the first electronic device. In response to receiving the login name and password, the second electronic device can send instructions to the first electronic device that cause a home state to be generated. On a banking site, the home state might include user information and account information, such as account balances.

A web-browser, is an example one type of common application that can be instantiated on an electronic device, such as the first electronic device, which allows an interface to be generated for outputting data and optionally accepting data/instructions. The web-browser on the first electronic can be configured to generate the interface in combination with data/instructions received from a remote electronic device, such as a second electronic device, via a network connection established between the two devices. As described herein, the term browsing is not limited to “web-browsing” performed using a web-browser. Instead, it is used to refer to the process where an interface for outputting and optionally inputting information is generated on a first electronic device in response to data/instructions received from a second electronic device via a network communication connection between the two electronic devices.

A web-browser is one type of application that can be utilized to in a browsing process. However, many other types of applications can also be used that are not strictly web-browsers. For example, many custom applications exist for smartphones and tablet computers that generate interfaces on these devices in response to communications with a remote device where these applications would not be considered web-browsers. Nevertheless, the purposes of discussions herein, the use of these types of applications can be considered to be included when different embodiments of secure browsing are described with respect to FIGS. 4-5C, as described as follows.

FIG. 4 is an interaction diagram showing communications between the thick client 10 and a customer facing security domain (CFSD) 28 at a central server 4 involving a secure browsing method 300. A block diagram including the thick client 10 and the CFSD is described above with respect to FIG. 2. In 302, a secure communication session can be set-up or established between the thick client 10 and the CFSD 28. Examples of setting up or resuming a secure communication session using a TLS protocol are described above with respect to FIG. 3A.

In 304, an on-line session between the thick client 10 and the CFSD 28 at the central server 4 can be established on top of the secure communication session. Via the on-line session, various services can be made available at the thick client 10. One example of a service that can be provided is secure browsing as is described in more detail as follows. Other examples of the on-line services, such as trust scoring 32, a user dashboard 36, electronic vault access 34 and trusted messaging 40 are described with respect to FIG. 2.

At some point during the on-line session in 304, the user of the thick client may decide to initiate a secure browsing session. For example, as soon as the on-line session in 304 is initiated, the user may decide to initiate a secure browsing or the user can engage in other services before secure browsing session. In some embodiments, the user can initiate in secure browsing without partaking in other services or the user can partake in other services without engaging in secure browsing.

The interface associated with the on-line session involving the thick client 10 and the CFSD 28 can be configured to accept an input that causes a secure browsing session to be initiated. For example, the session can be initiated in response to a mouse being clicked at a certain location on a display screen or in response to a touch input on a touch screen detected at certain location that triggers the secure browsing session. The secure browsing session can sit above and utilize the security methods described above with respect to FIGS. 3A and 3B.

In 308, a secure browsing request can be generated and sent to the CFSD 28 at central server 4. In one embodiment, after the secure browsing request is initiated, the user can be requested to enter third-party information that allows the third-party communication to be established. In one embodiment, the user may be requested to specify third-party information, such as a URL for the third party. In another embodiment, the user may be able to simply specify a third-party identifier and the service that they wish to obtain. For example, via the interface, the user might be able to specify a “bank name” and “account access” to initiate a secure browsing session involving account access at the bank. In another example, via the interface, the user might be able specify a “third-party name” for a shopping site and specify “shopping” to engage in purchases at the shopping site via secure browsing. In general, any type of web-site available on the web can be accessed via a secure browsing session.

In case of web browsing, the information included in the secure browsing request can be used to locate a third-party electronic device reachable via a network, such as the Internet, that hosts a third-party application that can fulfill the browsing request. In some embodiments, third-party application can generate a web-site that is compatible with a web-browser. Alternatively, the third-party application can be configured to work with a custom application executing on user's device that allows the user to access data from the third-party application. In one embodiment, the central server 4 can store a list of valid third-party web or network addresses or other information for various third-party devices that allows the devices to be contacted in response to a secure browsing request. In one embodiment, the addresses on the list can be pre-screened to ensure that the central server 4 contacts a valid device. After establishing communications with a device on the list, the central server 4 can engage or not engage in additional procedures as described herein to attempt to further authenticate the third-party electronic device.

Using the information in the secure browsing request and the list of valid addresses, the central server 4 can attempt to determine a web address or network address for a third-party electronic device that can satisfy the secure browsing request and then contact the associated third-party electronic device to establish communications. In other embodiments, the central server 4 can be configured to perform a search using a search engine to determine the information needed to contact a third-party electronic device that can fulfill the browsing request. Based on this information gathered on the fly, the central server 4 can attempt to establish communications with the third-party electronic device.

After a third-party electronic device is located that can provide the browsing activity identified via the information contained in the secure browsing request, the establishment of a secure browsing session can involve the establishment of a secure connection between the CFSD 28 and the third-party party electronic device, such as a device hosting a third-party web-site. The secure connection can be above and beyond the TLS session described with respect to FIG. 3A and can involve some of the methods described with respect to FIG. 3B. For example, the unlocking of the thick client private key in FIG. 3B may enable the authentication of the thick client and its associated user-controlled device for the purposes of signature verification of signed messages. The CFSD 28 may not be able to establish a secure connection with every site at a desired level of security. For example, if the CFSD 28 can't verify the authenticity of the third-party site then a secure browsing session may not be made available with the third-party site via the central server 4.

In some embodiments, the central server 4 can be configured to maintain a list of third-party sites for which secure browsing is available. Via the interface at the thick client 10, a user may be able to view and search for third-parties for which secure browsing is available. In one embodiment, the user may be able to specify particular third-parties for which they have relationship. These third-parties can displayed in the user interface at the thick client and the user may be able to select a particular one of these third-parties to initiate a secure browsing session with the third-party. For example, an interface button can be displayed that shows a logo for the third-party, such as a banking logo. In response, to receiving a selection of the interface button at the thick client 10, the secure browsing session with the specified third-party can be initiated. In some embodiments, the central server 4 can be configured to maintain a list of third-party sites for which secure browsing is to be denied.

In 308, a secure browsing request can be detected and a secure browsing request message can be generated. Previously, a first nonce (Nonce_1) may have been generated in 306. The first nonce may have been generated in response to the secure browsing request received in 308 or as part of the activities in 302 and 304. In one embodiment, it can be computed by applying a hash function to a specified part or entirety of the TLS set-up/resumption communications in 302. An integrity check value, such as a keyed hash value of the message can be generated. Keys used in generation and verification of integrity check values can be sourced from keys associated with a TLS session. The request can be digitally signed with a private key, such as the private key obtained as a result of the method described in FIG. 3B. Then, the message can be encrypted using the secure communication encryption keys, such as the keys associated with a TLS session.

In 310, the secure browsing request message including the third party information, certificate information associated with the thick client 10 and the first nonce can be sent to the CFSD 28 at central server 4. The certificate information can be used to obtain a signature verification public key used to verify the digitally signed message. In one embodiment, the certificate information can include the certificate itself. In another embodiment, the certificate information can be a certificate ID which can be used by the CFSD 28 at the server to access the certificate information. For example, this key may have been stored at the central server 4 as part of the TLS handshake or a successful response from the thick client 10 to central server 4 as a response to a challenge issued by central server 4.

In 312, the central server 4 can receive the request and decrypt it using the secure communication encryption keys, such as the TLS session keys. Then, it can verify the integrity check value by applying the same function, such as a keyed hash function, used at the thick client to generate the integrity check value and compare to the integrity check value received in the message where the integrity check value may be transmitted encrypted using a TLS session key. The generation and verification of the integrity check value may be based on a TLS session key that is distinct from a TLS session key used for encryption. If this comparison is valid, then the central server 4 can verify the signature over the request that was generated using the thick client private key by using the corresponding public key. As mentioned above, this value can be obtained from the thick client certificate. In addition, the central server 4 can verify integrity of the data in the request. In some embodiments, an integrity check value may be computed over ciphertext i.e. over encrypted data rather than plaintext data. In such case it may be possible to verify an integrity check value prior to performing a decryption operation.

Next, based on the third-party information, the central server 4 can check whether is able to establish a secure connection with the specified third-party of the type specified in the message. If it is able to verify all of the check values and is able to establish a secure communication connection with the third-party of the type specified in the message, then the central server 4 can generate a response message indicating that the request can be fulfilled. Otherwise, the central server 4 can generate a response message indicating the response can't be fulfilled.

In one embodiment, a message indicating the response can't be fulfilled can specify a reason and/a possible remedial action. For example, if a secure connection can't be established with the third-party because the third-party can't be identified or authenticated, then this information can be included in the message and output to the user. In another example, the central server 4 may try to establish initial communications with the third-party, such as third-party server. If the initial communications can't be established, such as if the third-party server is down, then the central server 4 might notify the user to try again later when the third-party server is available. In another example, if party of the request message was lost, the central server 4 may request the thick client 10 to resend the message and in response the thick client 10 may resend the message and the central server 4 can attempt to verify it.

In 316, if the request can be granted, the thick client may attempt to initiate a secure communication session with a third-party server associated with the identified third-party, such as an SSL or TLS communication session. In 314, the secure browsing request response including the request status is sent to the thick client 10 from the central server 4. In 318, the thick client 10 can verify the request and determine the request status. If the request status indicates the secure browsing is to start then secure browsing can begin in 322. If the request status indicates the secure browsing is not to begin, the thick client 10 can attempt to perform any possible remedial actions, such as resending request, and notify the user of the request status.

In 320, a second nonce (Nonce_2) can be generated. In one embodiment, the second nonce can be generated by applying a one-way function, such as a hash function, to a specified part or the entirety of request and response messages sent between the thick client 10 and central server 4, such as request and response in 310 and 314. The second nonce can be used for a follow on request response regarding the same or a different third-party.

In 322, the thick client generates and sends a new secure browsing request to the server. The request can specify a third-party the same as or different from the third-party from the request in 308. The request sent in 324 can include the second nonce and the third party information. The central server 4 can receive the request and respond again as previously described.

In one embodiment, the central server 4 can be configured to allow the thick client to engage in a number of secure browsing sessions with multiple third-parties simultaneously. The number of parallel third party sessions can be limited to some amount, such as five parallel sessions. The same TLS encryption keys can be used for each of the five parallel sessions. In another embodiment, the central server 4 can be configured to allow a user to engage in only one secure browsing session at a time. Thus, when a user is engaged with a first secure browsing session involving a first third-party and initiates a second secure browsing session involving a second third-party then the first secure communication session may be terminated.

In other embodiments, at various times, the central server 4 can be engaged in secure browsing sessions with a number of different thick clients at the same time where the third-party for each session is the same. For example, ten users may have simultaneously established a secure browsing connection to access their account at the same bank. In one embodiment, a separate secure communication connection, such as a TLS session, can be established between the central server 4 and the third-party site for each secure browsing session. For example, a first secure browsing session and a second secure browsing session between the central server and a first thick client and a second thick client where clients are communicating with the same third-party can involve, a first secure communication session between the first thick client and the central server, a second secure communication session between the second thick client and the central server, a third secure communication session between the server and the third-party and a fourth secure communication session between the server and the third-party.

In another embodiment, a single secure communication connection between the central server 4 and the third-party site can be used to carry information for multiple secure browsing sessions. For example, a first secure browsing session and a second secure browsing session between the central server and a first thick client and a second thick client where both clients communicate with the same third-party can involve, a first secure communication session between the first thick client and the central server, a second secure communication session between the second thick client and the central server and a third secure communication session between the server and the third-party. The third secure communication session can include communications to or from the first thick client and the second thick client.

Next, with respect to FIGS. 5A, 5B and 5C, additional details and examples involving secure browsing are described. With respect to FIG. 5A, the secure browsing communications are described at a high-level. Then additional details of the secure browsing communications are described with respect to FIGS. 5B and 5C.

FIG. 5A is an interaction diagram showing communications between a thick client 10, a central server including a customer facing security domain 28 and a third-party server 6 where the central server 4 mediates communications using a secure browsing method 400. In 402, the central server 4 has received and approved a secure browsing request from the thick client 10. In response, in 404, the central server initiates or resumes a secure communication session, such as a TLS session with the 3^{rd} party. As an example, initial TLS communications are shown in 406. If the third-party server 6 is commonly utilized by many different users, then the central server 4 may already be communicating with the third-party server 6 for another secure browsing session. In this instance, the central server 4 may simply utilize already on-going secure communication session and its associated encryption keys.

In particular embodiments, beyond establishing a secure communication session with the third-party server 6, the central server 4 may implement some of the thick client steps described with respect to FIG. 3B. In one embodiment, the third-party server 6 can implement a thick client application as described with respect to FIG. 3B. In another embodiment, the third party can be a second user. The second user can implement a thick client on one of their user controlled devices, such a smart phone or tablet computer and then an additional application that sits on top of the thick client. In this example, the secure browsing can involve a first user performing an on-line interaction with the second user via an application that sits on top of the thick client application executing on the second user's device.

As an example of a peer-to-peer communication, two user controlled devices can establish communications with one another via a local connection, such as a direct blue-tooth connection. For example, the first user controlled device can be smart phone and the second user controlled device can be tablet computer. To perform a secure transaction, secure communication connections can be established between the first user device and the central server 4 and between the second user device and the central server 4. Then, a secure browsing session can be initiated between the first user controlled device and the second user controlled device via the central server 4 where an application executing on the second user device acts like an application executing on a third-party server. For example, the application on the second user device may allow a financial transaction to be performed such as a transfer of funds from the first user to the second user.

In 408, the third-party server 6 can generate and send application data. For example, application data that allows a web-page to be displayed on the thick client device can be generated. The application data can be encrypted using encryption keys, such as TLS encryption keys for TLS session between the 3^{rd}-party server and the central server 4. The application data can be sent in 410. In 412, the central server 4 can decrypt the received application data using the appropriate encryption keys, such as the TLS session keys.

Next, in 412, the central server 4 can encrypt the application data using encryption keys associated with the secure communication channel between the central server 4 and the thick client 10, such as TLS session keys between the central server 4 and thick client 10. In this embodiment, the encryption keys between the central server 4 and the thick client 10 are different than the encryption keys between the central server 4 and the third-party server 6. In addition, only the central server 4 may know the encryption keys for both communication connections. Thus, the third-party server 6 may not be able to decrypt communications sent directly from the thick client 10 and vice versa.

In 416, the central server 4 can store secure browsing session related data such as how much data was sent, when it was sent and from whom it was sent. A database can be established that includes an identifier that uniquely identifies a secure browsing session, e.g., a secure browsing session ID. Information associated with the secure browsing session, such as i) a GUID associated with the thick client, ii) an identifier associated with the third-party client, iii) when the secure browsing session is instantiated, iv) when the secure browsing session is terminated and v) stats generated during the session like information regarding when information was sent and how much information was sent, can be stored to the database. In one embodiment, if the central server 4 doesn't detect any activity over some period, then the central server 4 can be configured to automatically terminate the secure browsing session.

The database information can be used to derive analytics for the purposes of determining anomalous behavior. For example, when a user has a history of engaging with a third-party site only during a particular time period with particular frequency, the central server 4 can be configured to flag a secure browsing session where the user is now engaging in the secure browsing sessions at a non-typical time period or with a non-typical frequency, such as many times over a short time period. In response to determining anomalous behavior, a remedial action can be taken. For instance, the central server 4 can send a message via a previously specified secondary communication channel, separate from the communication channel associated with the thick client, which notifies the user of the activity. This monitoring can be performed without actually examining the contents of the data that is being transferred. Thus, allowing the privacy of the data that is being transmitted to be maintained.

In 414, the application data encrypted with encryption keys that can be decrypted by the thick client 10 can be sent to the thick client. In 418, the thick client 10 can receive the application data and decrypt it. Then, the application data can be further processed to affect an interface generated on the user-controlled device associated with the thick client. For instance, the application data can include html commands that are processed by a web-browser executing on the user-controlled device such that a web page interface is output on the user-controlled device.

In 420, the user-controlled device can receive response data via one of the input devices associated with the user interface. The response data can be received by the thick client application and processed. For instance, the thick client application can encrypt the response data. The encrypted response data can be sent to the central server 4. In 424, the central server 4 can receive the response data, decrypt it and then encrypt it using encryption keys that are known by the third-party server. In 426, the properly encrypted response data can be sent to the third-party server 6. In addition, in 428, the central server 4 can determine and update the secure browsing information database according to the response data that was received.

In 430, the encrypted response data can be received by the third-party server 6 which can decrypt it. The decrypted response data can be passed to an application executing on the third-party server 6, such as a banking application. The response data can cause changes to the application that is executing. In response, new application data can be sent to the central server 4 as described in 408.

In alternate embodiments, the central server 4 can be configured to broker communications between a client and a third-party device but then withdraw from the communications once the communication has been brokered. For example, the central server 4 can establish communications with a client and perform one or more steps to authenticate the client and its associated user as described herein. For example, all or a portion of the method 250 involving the thick client 10 and central server 4 described with respect to FIG. 4 can be implemented. After some level of authentication has been established, in FIG. 5A, the central server 4 can receive a secure browsing request 402 from the client, such as client 10.

In response to the secure browsing request, the central server 4 may broker a communication connection between the 3^{rd} party server 6 and the thick client. As part of the brokering process, the central server 4 may take none or one or more steps to authenticate the 3^{rd} party server 6. For example, the central server 4 may simple establish communications with a web-link contained in the secure browsing request without checking the address. In another embodiment, the central server 4 may attempt to determine whether the web-link contained in the secure browsing request is valid. In another embodiment, based upon the information included in the secure browsing request, such as a name and requested server, the central server 4 may attempt to locate a device that provides the requested service.

Next, the central server 4 can attempt to contact the identified third party device, such as server 6. The central server 4 may or may not implement methods to authenticate the third-party server. In one embodiment, the central server 4 can establish a TLS session as shown in 406 with the third-party device which as described above with respect to FIG. 3A can involve some authentication (e.g., the server 6 can send central server 4 it's certificate). After establishing the communications, the central server 4 can hand off the communications to the third-party server 6 and then withdraw from the communications. Upon withdrawing, the third party can store a record of the brokered communications while the thick client 10 and server 6 continue to engage in communications.

For web-site navigation, one security advantage is that the browser on the user's device can be bypassed to establish the communication and the trust relationship between the user and the central server 4 can be leveraged. This approach may work readily for those 3^{rd}-party service providers that present a login screen after the TLS handshake (as opposed to before). Note the 3^{rd}-party login screen is distinct from the central server login process that occurs between a user at a thick client and the central server as was described with respect to FIG. 3B.

As an example of brokering communication, the central server 4 can establish a TLS session with the thick client 10 and then receive a secure browsing request from the thick client 10. The central server 4 can establish communications with the third-party server 6. The central server 4 or may not attempt to authenticate the server 6. Then, the central server 4 can hand-off TLS session keys between the thick client 10 and the central server 4 to the server 6. The third-party server 6 can use the TLS session keys to continue to carry out communications with the thick client 10. Whereas, the central server 4 can withdraw from the communications and store a record that it brokered communications between the thick client 10 and the 3^{rd} party server 6.

As an alternative, a TLS handshake between the 3^{rd}-party service provider and the central server 4 can be set up using the CFSD HSM (see FIG. 2), which can then pass the TLS session information to the client of the user, such as thick client 10, from which the secure browsing request was received. In one embodiment, the TLS session information is encrypted so that it is usable only by the intended client, such as 10. Thus, in the brokering process, the communication information can be handed off to the client or to the 3^{rd} party device.

The CFSD HSM has only transient access to this TLS session information, which the HSM deletes/overwrites as soon as it has been encrypted for the client. The encryption can be such that the CFD HSM cannot later recover this TLS session information (e.g., if the encryption is done using an ephemeral Diffie-Hellman key generated by the CFD HSM). Using this process, the central server 4 can be prevented from later entering back into the communications.

In an alternative embodiment, the central server 4 may no longer be a proxy, but still can act as a mediator/intermediary). As an example, the CFD HSM can monitor incoming legacy website TLS traffic as being intelligible to the client, such as 10, which has initiated a login with the CFD HSM at the central server 4. The CFD HSM can track signature verification public key associated with central server 4 and login username, and can expect signed responses to its periodic queries to the client, such as 10, regarding the incoming legacy website TLS traffic. This approach can work despite the fact that the CFD HSM cannot access the underlying plaintext of that TLS traffic. A security advantage is that an insider attack at the central server 4 can be thwarted.

In yet other embodiments, the communication methods above can be used to allow a client, such as the thick client 10, to perform anonymous browsing. Whether brokering a communication or mediating a communication, when the central server is used to establish communications with a third-party web-site, unless the web-site requires a log-in screen to gain access, the identity of the client and its associated device doesn't have to be revealed to the web-site to establish communications. Thus, the user can browse anonymously and not reveal this information.

Currently many/most businesses identify and track visitors to web sites. They can identify these visitors as either specific individuals or possibly only to as a specific computer (i.e., without a known association to a specific individual). Identification to sites can be made using any or a combination of multiple factors, such as i) cookies that may have been placed previously which may be specifically associated with a known individual who previously identified himself/herself or may be associated only with that visiting computer or 2) unique identifying characteristics of the visiting computer, such as its IP address, general physical location, browser type, operating system and possibly other data. Using anonymous browsing, the collection of this data can be prevented if the user so chooses.

FIG. 5B is an interaction diagram showing a method 450 of communications between a thick client 10, a central server 4 and a third-party server 6 where data is sent from the thick client 10 and received by third-party server 6 via the central server. In this example, a secure browsing session has been instantiated involving the three devices. In 452, an application executing on the thick client 10 can receive user data. For example, the user data can be input via an input interface generated on the user-controlled device associated with the thick client.

The user data can be passed to the thick client application that is executing on the user controlled device. In 454, the thick client application can generate an integrity check value and may encrypt it. For example, the integrity check value can be based on keyed hashing and can be generated using a TLS session key for a TLS session between the thick client 10 and the central server. Also, for example, the user data can be encrypted using TLS session keys for a TLS session between the thick client 10 and the server. Further, as described above, the thick client can digitally sign the message using its private key. In one embodiment, information about the access point, such as information about the user controlled device on which the thick client is being executed, and information about the user engaging in the communications can be sent with the input data. In 456, the encrypted user data, the integrity check value and optionally the access point information and the user information can be sent alone or in combination to the central server 4.

In 458, the central server 4 can receive the message from the thick client 10, decrypt the data and verify the integrity check value. When TLS protocol is used, the user data can be decrypted using the TLS session keys for the session established between the client 2 and the central server 4. Further, when TLS protocol is used to generate integrity check value, the verification of the integrity check value is done using a TLS session key for the session established between the client 2 and the central server 4. In a particular embodiment, the access point information and/or the user information can be used to generate a score. In one embodiment, one aspect of the score can be related to how much trust can be placed upon a user's presented identity based upon validation from sources separate from the central server 4. Another aspect of the score can be related to an evaluation of how secure is the access point that is being used to access the central server 4.

Based upon the score, the central server 4 can be configured to block or allow the user data to be sent to the third-party server 6. This method can also be applied to data arriving from the third-party server that is intended for the thick client 10. For example, a score can be generated for the third-party that controls the third-party server related to their presented identity and a score can be generated for the electronic platform used by the third-party. Based upon one or both of the scores alone or in combination, the central server 4 can be configured to block transmission of all or portion of the data received from the third-party server 6.

In one embodiment, the user of the thick client 10 or the owner of the third-party server 6 can independently specify scoring levels to utilize. Based upon the thresholds established according to the specified scores, information can be blocked in either direction. For example, based upon scores selected by the owners of the third-party server, information from certain thick clients can be blocked by the central server 4. Further, based upon scores selected by the user of the thick client, information from certain third-party sites can be blocked from reaching the thick client by the central server 4.

In another embodiment, the user data can be digitally signed at the thick client 10 as was described with respect to FIG. 3B. The central server 4 can verify the digital signature of the thick client 10. Data associated with the digital signature can be stored as part of the secure browsing session information. The digital signature data can provide evidence that the user data sent during the secure browsing session was received from a known thick client identified according to its digital signature. This process can also be utilized with the information received from the third-party server 6 that is digitally signed by the third-party server 6.

In 460, the user data can be encrypted and an integrity check value can be generated. In one embodiment, the data can be encrypted using encryption keys associated with a TLS session established between the third-party server 6 and the central server 4. Also in one embodiment, the integrity check value can be generated using a TLS session key. In 462, a message including the encrypted user data can be sent to the third-party server 6. In 464, the user data that is received can be decrypted at the third-party server 6 and the integrity check value can be verified. In one embodiment, the data can be decrypted using the TLS session keys associated with the central server 4 to third-party server 6 communication session. Also in one embodiment, the integrity check value can be verified using a TLS session key. If the user data checks out, it can be supplied to an application program executing on the third-party server 6.

FIG. 5C is an interaction diagram showing a method of communications 470 between a thick client 10, a central server 4 and a third-party server 6 where data is sent from the third-party server 6 and received in the thick client 10 via the central server. In 472, an application executing on the third-party server 6 can generate 3^{rd} party data that is to be sent to the thick client. The third-party server 6 can generate an integrity check value and encrypt the 3^{rd} party data and may encrypt the integrity check value. In one embodiment, the 3^{rd} party data and the integrity check value can be encrypted using TLS session keys between the third-party server and the central server. Also in one embodiment, the integrity check value can be based on keyed hashing and can be generated using a TLS session key for a TLS session between the third party server and the central server. In 474, the encrypted 3^{rd} party data can be sent to the central server 4. In 476, the server can decrypt the 3^{rd} party data and verify the integrity check value. Information related to the received data can also be stored as secure browsing session data.

As previously described, the 3^{rd} party data can include instructions and/or data that allow an interface of some type to be generated on the thick client 10. For example, the 3^{rd} party data can include mark-up language instructions, such as in HTML 5.0 instructions, and associated image data that is to be placed on the page. In one embodiment, in 478, the 3^{rd} party data can be pre-processed at the central server 4. For example, mark-up language instructions and/or associated data can be examined to detect vulnerabilities designed to exploit security holes in various browser programs. When malicious instructions are detected, it can be removed prior to being sent to the thick client. The detection of malicious instructions can affect a score associated with the site that sent the instructions, such as the trust score or the access score. The trust score or the access score can be adjusted upward or downward as appropriate to reflect the included vulnerabilities received from the site.

Further, the mark-up language instructions can be partially processed so that a completed page or portions of a completed page are sent to the thick client instead of the instructions used to construct entire the page. In another embodiment, for security purposes, non-essential portions of the 3^{rd} party data, such as portions used to generate non-essential portions of a web-page can be stripped from the data such that only 3^{rd} party data for generating the essential portions of the interface may be sent to the thick client 10. Thus, because the 3^{rd} party data may be altered, the interface instructions received at the central server 4 can be different from the interface instructions that are sent to the thick client 10. Hence, the interface generated at the user controlled device associated with the thick client 10 can be different than if the thick client 10 received the interface instructions directly from the third-party server 6.

In 480, the central server 4 can encrypt the processed 3^{rd} party data and generate an integrity check value. In one embodiment, the processed 3^{rd} party data can be encrypted using TLS session keys between the central server 4 and the thick client 10 determined during a TLS handshake as described above with respect to FIG. 3A. Also in one embodiment, an integrity check value over the processed 3^{rd} party data can be generated using a TLS session key between the server 4 and the thick client 10. The encrypted and processed 3^{rd} party data can be sent in 482. In 484, the encrypted and processed 3^{rd} party data can be received at the thick client 10. The data can be decrypted and its integrity checked. If the processed 3^{rd} party data is verified then it can be passed to an interface application. Then, interface application can receive the processed 3^{rd} party data and generate the interface on the user-controlled device according to the processed 3^{rd} party data.

FIG. 6 is a block diagram of a server 512 and user controlled electronic device 532 in accordance with the described embodiments. The security functions provided by the central server 512 can be instantiated as a set of software programs, executed on one or more processors, such as 502. The central server can utilize a plurality of servers and is not limited to a single device. The computing devices in the system, such as 512 and 532, can be configured to communicate with one another via a network, such as network 516. Thus, each device can include network interfaces, such as 508 and 526 that support one or more different network communication protocols.

Each device can include processor(s) for executing software programs, volatile memory for storing executable code, non-volatile memory, which can be mass storage, for storing data, peripheral devices for inputting and outputting data from the device and one or more internal busses for allow data transfer between the devices. As examples, central server 512 includes processor 502, volatile memory 504, mass storage device 506 and network interface 508 and peripheral devices 510 and user computing device 532 includes processor 520, volatile memory 522, mass storage 524, network interface 526 and peripheral devices 528. The peripheral devices, such as 510 and 528, can include input and output devices that allow secure data to entered, viewed and extracted from the system. In one embodiment, the user computing device 1222 can be a portable device, such as tablet computer, laptop or smart phone.

The various aspects, embodiments, implementations or features of the described embodiments can be used separately or in any combination. Various aspects of the described embodiments can be implemented by software, hardware or a combination of hardware and software. The computer readable medium is any data storage device that can store data which can thereafter be read by a computer system. Examples of the computer readable medium include read-only memory, random-access memory, CD-ROMs, DVDs, magnetic tape and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents. While the embodiments have been described in terms of several particular embodiments, there are alterations, permutations, and equivalents, which fall within the scope of these general concepts. It should also be noted that there are many alternative ways of implementing the methods and apparatuses of the present embodiments. It is therefore intended that the following appended claims be interpreted as including all such alterations, permutations, and equivalents as fall within the true spirit and scope of the described embodiments.

What is claimed is:

1. A method in a server including a processor and memory, the method comprising:
establishing in the processor a first communication session with a first electronic device;
receiving in the processor from the first electronic device a secure browsing request;
based upon information included in the secure browsing request, locating in the processor a third-party electronic device hosting on a network a third-party application that fulfills the secure browsing request;
establishing in the processor a second communication session with the third-party electronic device; and
establishing in the processor a third communication session between the first electronic device and the third-party electronic device wherein the third communication session enables data generated from the third party application to be received by the first electronic device.

2. The method of claim 1, wherein data generated from the third party application includes instructions that enable a web-page to be generated and output using a web-browser executing on the first electronic device.

3. The method of claim 2, wherein the third communication session is established and maintained without revealing an identity of a user of the first electronic device or identification information associated with the first electronic device allowing the user to view the web-page anonymously on the first electronic device.

4. The method of claim 1, wherein the secure browsing request includes a name of the third-party and wherein the third-party electronic device is located using the name of the third-party.

5. The method of claim 4, wherein the secure browsing request further includes a requested service and wherein the third-party electronic device is located using the name of the third-party and the requested service.

6. The method of claim 4, wherein the name of the third-party is used to determine a web address associated with third-party and wherein the second communication session is established using the web-address.

7. The method of claim 1, further comprising: determining a symmetric encryption key to use for encrypting data in the first communication session.

8. The method of claim 7, wherein the symmetric encryption key is determined using a transport layer security (TLS) handshake between the first electronic device and the server.

9. The method of claim 7, further comprising: sending a message including the symmetric encryption key to the third-party electronic device wherein the third communication session includes direct communications between the first electronic device and the third-party electronic device using the symmetric encryption key such that the server is by-passed.

10. The method of claim 1, further comprising: determining a symmetric encryption key to use for encrypting data in the second communication session.

11. The method of claim 10, wherein the symmetric encryption key is determined using a TLS handshake between the third-party electronic device and the server.

12. The method of claim 11, further comprising: sending a message including the symmetric encryption key to the first electronic device wherein the third communication session includes direct communications between the first electronic device and the third-party electronic device using the symmetric encryption key such that the server is by-passed.

13. The method of claim 1, further comprising: determining a first symmetric encryption key to use for encrypting data in the first communication session sent between the first electronic device and server and determining a second symmetric encryption key to use for encrypting data in the second communication session sent between the first server and the third-party electronic device.

14. The method of claim 13, further comprising: receiving in the server the third-party application data that is encrypted with the second symmetric encryption key, decrypting the encrypted third-party application data with the second symmetric encryption key, encrypting the third party application data with the first symmetric encryption key and sending the third-party application data encrypted with the first symmetric encryption key to the first electronic device.

15. The method of claim 14, wherein the third-party application is used to generate a web-page on the first electronic device.

16. The method of claim 13, further comprising: receiving in the server a message including input data for the third-party application from the first electronic device wherein the input data is encrypted using the first symmetric encryption key, decrypting the input data using the first symmetric encryption key, encrypting the input data using the second symmetric encryption key and sending the input data encrypted using the second symmetric key to the third-party electronic device.

17. The method of claim 16, wherein the input data includes a user name and a password used to grant access to features of the third-party application.

18. The method of claim 13, wherein only the server possess knowledge of both the first symmetric encryption key and the second symmetric encryption key.

19. The method of claim 1, further comprising: receiving a login request from the first electronic device, sending a challenge vector to the first electronic device, receiving a response to the challenge vector from the first electronic device and when the response to the challenge vector is correct, sending a login display message to the first electronic device.

20. The method of claim 19, wherein the challenge vector includes information used by the first electronic device to retrieve one or more random bits previously hidden in a persistent memory on the first electronic device.

21. The method of claim 19, prior to receiving the login request, sending first random information, a global unique ID and instructions for hiding the first random information in a persistent memory associated with the first electronic device.

22. A computer readable storage medium including computer program code for execution by a processor to establish a secure online browsing session, said computer readable storage medium comprising:
computer code for establishing in the processor a first communication session with a first electronic device;
computer code for receiving in the processor from the first electronic device a secure browsing request;
computer code for, based upon information included in the secure browsing request, locating in the processor a third-party electronic device on a network hosting a third-party application that fulfills the secure browsing request;
computer code for establishing in the processor a second communication session with the third-party electronic device; and
computer code for establishing in the processor a third communication session between the first electronic device and the third-party electronic device wherein the third communication session enables data generated from the third party application to be received by the first electronic device.
